(19) United States
(12) Patent Application Publication
(10) Pub. No.: US 2009/0112678 A1
(43) Pub. Date: Apr. 30, 2009

(54) SYSTEM AND METHOD FOR KNOWLEDGE MANAGEMENT

(75) Inventor: Ngoc Luzardo, Irvine, CA (US)

Correspondence Address: GRANT R CLAYTON;CLAYTON HOWARTH & CANNON, PC, P O BOX 1909, SANDY, UT, 84091-1909, US

(73) Assignee: INGRAM MICRO INC., Santa Ana, CA (US)

(21) Appl. No.: 12/259,179

(22) Filed: Oct. 27, 2008

Related U.S. Application Data
(60) Provisional application No. 61/000,527, filed on Oct. 26, 2007.

(51) Int. Cl. G06Q 10/00; G06F 17/30

(52) U.S. Cl. 705/8; 705/7

(57) ABSTRACT

A system and method for knowledge management in an organization. The system and method employs an intranet site whereby members of the organization can easily and efficiently access explicit knowledge and tacit knowledge relevant to complete processes in an organization. As members of an organization communicate and collaborate with each other using the present disclosure, new knowledge or ideas or best practices may form as a result of the collaboration which then should also be captured and codified as explicit knowledge.

### CROSS-REFERENCE TO RELATED APPLICATIONS

This application claims the benefit of U.S. Provisional Application No. 61/005,527, filed Oct. 26, 2007, which is hereby incorporated by reference herein in its entirety, including but not limited to those portions that specifically appear hereinafter, the incorporation by reference being made with the following exception: In the event that any portion of the above-referenced provisional application is inconsistent with this application, this application supercedes said above-referenced provisional application.

### STATEMENT REGARDING FEDERALLY SPONSORED RESEARCH OR DEVELOPMENT

Not Applicable.

### BACKGROUND

1. The Field of the Invention

The present disclosure relates generally to systems and methods for managing knowledge, and in particular, but not necessarily entirely, to intranet-based systems and methods for managing knowledge within an organization.

2. Description of Background Art

Any organization, regardless of its size, faces significant challenges in regards to managing the vast amount of knowledge required to efficiently operate in a global marketplace. The process of managing knowledge through the use of technology will regularly be referred to herein as “knowledge management” or “KM.”

Knowledge may exist as two types within an organization, namely, explicit knowledge and tacit knowledge. As used herein, the term “explicit knowledge” may refer to information which can be documented and stored in a tangible manner, such as in a database. As used herein, the term “tacit knowledge” may refer to any information that cannot be easily documented or stored in a tangible manner and includes a person's talent, intelligence, intuition and experience. Organizations recognize that both explicit knowledge and tacit knowledge are critical organizational assets. Indeed, the manner in which organizations manage their explicit and tacit knowledge may very well determine an organization's success in the world. Moreover, as used herein the term “document” may refer to any type of stored information including textual documents, audio data, video data, or any other information and data regardless of the format in which it is stored.

Organizations face several hurdles in managing explicit knowledge and tacit knowledge. Some of these hurdles include the following: information overload and chaos; obsolete technology; talent and knowledge leaving the organization through personnel turnover; capturing and sharing best practices within the organization; duplication of effort, i.e., “recreating the wheel;” difficulty finding relevant information within the organization; and, the protection of knowledge assets from competitors.

Knowledge is typically difficult to locate in large organizations because it is not well categorized, classified or organized. Further, individuals within an organization may not search for the information as they may not know that the information even exists. In addition, even when the knowledge has been codified and stored, the knowledge may not be well written, organized or laid out thereby making it difficult to find or comprehend the information. Further, the knowledge may be out of date, thereby making the knowledge less helpful. As a result of an organization's inability to effectively manage its knowledge, misinterpretation of the knowledge, lower productivity, and an increased need for training will be present.

One difficulty facing organizations in the their quest to manage their knowledge is that the knowledge within a given organization may be stored in a variety of locations and formats, including intranets, e-mails, computer memory devices, department and personal network memory devices, hard copy paper formats, and a wide variety of databases. In addition, the personal knowledge and work experiences in peoples' heads are typically not captured or documented during the operation of the currently available knowledge management systems.

While some previously available knowledge management systems have been developed, these previously available knowledge management systems have been inadequate to address the need for managing both explicit knowledge and tacit knowledge on a large scale suitable for a worldwide organization. In particular, many organizations have in the past employed an intranet, which is a private and restricted-access network that enables organizations some ability to share their resources. However, while the use of an intranet for managing knowledge is a step in the right direction, there still exists significant room for improvement. In particular, the previously available intranet systems for managing knowledge have done little to reduce the problems outlined above. In some instances, the use of an intranet within an organization may actually increase the lack of knowledge management.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a diagram of a business organization according to an exemplary embodiment of the present disclosure;

FIG. 2 is a diagram of a knowledge management system architecture according to an exemplary embodiment of the present disclosure;

FIG. 3 is a diagram of a portal leading to private inter-group and private intra-group spaces according to an exemplary embodiment of the present disclosure;

FIG. 4 is a diagram of a portal leading to public client-facing spaces according to an exemplary embodiment of the present disclosure;

FIG. 5 is an organizational structure suitable for implementing a knowledge management system with respect to the organization shown in FIG. 1 pursuant to an exemplary embodiment of the present disclosure;

FIG. 6 is a diagram of a private group space content metadata pursuant to an exemplary embodiment of the present disclosure;

FIG. 7 is a diagram of a public group space content metadata pursuant to an exemplary embodiment of the present disclosure;

FIG. 8 is a diagram of security and access to a knowledge management system pursuant to an exemplary embodiment of the present disclosure;

FIG. 9 is a diagram of a knowledge management system pursuant to an exemplary embodiment of the present disclosure;

FIG. 10 is a flow chart showing one exemplary process for managing knowledge pursuant to the present disclosure;

FIG. 11 is a flow chart showing one exemplary process for managing knowledge pursuant to the present disclosure;

FIG. 12 is a flow chart showing one exemplary process for managing knowledge pursuant to the present disclosure;

FIG. 13 is a flow chart showing one exemplary process for managing knowledge pursuant to the present disclosure; and

FIG. 14 is a flow chart showing one exemplary process for managing knowledge pursuant to the present disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

It must be noted that, as used in this specification and the appended claims, the singular forms “a,” “an,” and “the” include plural referents unless the context clearly dictates otherwise. In describing and claiming the present disclosure, the following terminology will be used in accordance with the definitions set out below. As used herein, the terms “comprising,” “including,” “containing,” “characterized by,” “having” and grammatical equivalents thereof are inclusive or open-ended terms that do not exclude additional, unrecited elements or method steps.

As used herein, the term “organization” may mean any arrangement which pursues collective goals whether for profit, non-profit, or other purposes, including, but not limited to: a partnership, incorporated or unincorporated association, subsidiary, government or governmental subdivision or agency, division, team, firm, corporation, limited liability company, trust or other form of business or legal entity, church, social group, group of people having a common interest no matter how loosely affiliated, and any combination thereof.

As used herein, the term “knowledge” may mean the interaction between information and human beings, including explicit knowledge and tacit knowledge.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software code, sometimes referred to as computer readable instructions, for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Turning now more particularly to the present disclosure, applicant has discovered a novel knowledge management system for centralizing the knowledge of an organization, including the explicit knowledge and tacit knowledge of the organization. The present disclosure makes knowledge more widely available to members of an organization and ensures that the knowledge is accurate, relevant, up-to-date and in the best format. The present disclosure further allows members of an organization to choose the information that is the most important to them and organizes the information to best support their individual workflow. The present disclosure may also push information to individuals based on their information preferences as well as what the organization thinks they need to know. The present disclosure further allows members of the organization to collaborate on the knowledge and innovate to develop best practices. The present disclosure secures and protects the knowledge, and is scalable and flexible to accommodate growth and geographical dispersion.

The present disclosure is particularly useful for organizing the knowledge of a business organization, but may also be suitable for governments and other entities. In one illustrative embodiment, the present disclosure focuses on the key business processes and identifies the knowledge that is most critical to them and the particular information related to the business processes that needs to be captured, codified, protected and shared, and how to best organize that knowledge.

Once the key business processes have been identified, information designers may develop the documentation and templates, intranet site, or other media to avoid the problem of ineffective or poorly written and designed documentation, web sites, or other media, and to ensure knowledge is captured/delivered in the most effective medium. Once captured and codified, the information may be deployed to an intranet.

Thus, the present disclosure is able to address the following organizational issues: information overload and chaos, talent leaving the company and the knowledge capital that leaves with them, capturing and sharing best practices across an organization, eliminating duplication of effort, acquisitions and combining knowledge of organizations, managing reduction, reorganization, retooling a workforce and/or protection of knowledge assets.

At the individual or team level, the present disclosure serves to quickly build knowledge or “get people up to speed.” Further, individuals and teams are able to efficiently leverage contractor knowledge and experience. Another advantage of the present disclosure is that by documenting key business processes, the future implementation and completion of the processes is made simpler. In addition, an organization implementing the present disclosure is able to build additional knowledge and capabilities within the organization to thereby reduce reliance on external contractors.

The present disclosure may include an intranet site that is designed to track, manage, and centralize all project communications and collaboration. The present disclosure may further include training key individuals on various communications and collaboration tools to increase project productivity. The present disclosure may also include the deployment of an intranet to facilitate knowledge management.

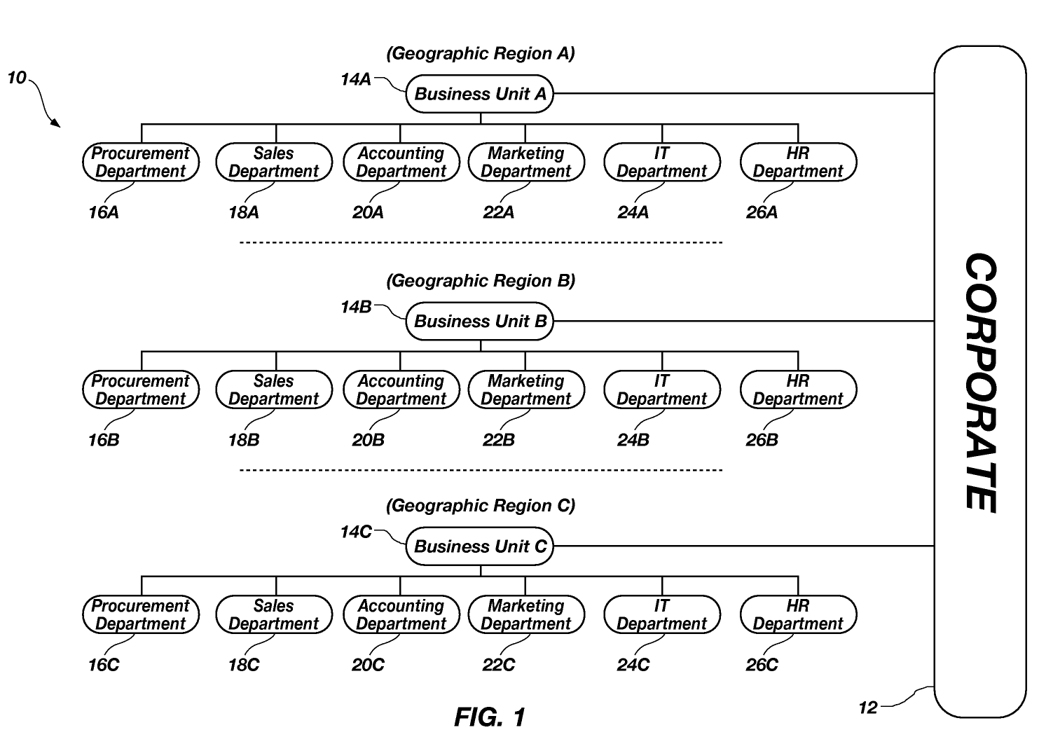

Referring now to FIG. 1, there is depicted an organizational chart of an organization 10 in need of knowledge management pursuant to an embodiment of the present disclosure.

As shown in FIG. 1, the organization 10 may be a business organization, such as a world-wide corporation. It will be appreciated, however, that the principles of the present disclosure for knowledge management may be applied to any organization, including governmental organizations, religious organizations, non-profit organizations and other organizations. The organization 10 may comprise a corporate headquarters 12, which is the entity at the top of the hierarchical structure of the organization 10. The corporate headquarters 12 may comprise a variety of top level officers, including a chief executive officer, chief financial officer, chief information officer, chief operations officer and others as is known to one having ordinary skill in the art. The corporate headquarters 12 may further include managers who concern themselves with the day-to-day operations of the organization 10.

The organization 10 may further include business units 14A, 14B, and 14C. The business units 14A, 14B, and 14C may each be assigned to a specific geographic region, such as Geographic Regions A, B, and C, respectively. The business units 14A, 14B, and 14C are responsible for the successful completion of the corporate affairs in their respective Geographic Regions A, B, and C. The business units 14A, 14B, and 14C may be similarly organized since their roles and responsibilities are the same, but just carried out in different geographic regions. In particular, the business unit 14A may comprise a procurement department 16A, a sales department 18A, an accounting department 20A, a marketing department 22A, an IT (Information Technology) department 24A and an HR (Human Resources) department 26A. Likewise, the business unit 14B may also comprise a procurement department 16B, a sales department 18B, an accounting department 20B, a marketing department 22B, an IT department 24B and an HR department 26B. Finally, the business unit 14C may comprise a procurement department 16C, a sales department 18C, an accounting department 20C, a marketing department 22C, an IT department 24C and an HR department 26C. It will be appreciated that the organization 10 may have more than just the three business units 14A, 14B and 14C depicted in FIG. 1. It will be further appreciated that the business units 14A, 14B, and 14C may comprise additional or fewer departments than those specified herein and that those listed above are exemplary in name and number only.

It will be appreciated that the procurement departments 16A, 16B, and 16C may have similar roles and duties within the each of the their respective business units 14A, 14B and 14C. Likewise, it will be appreciated that the sales departments 18A, 18B, and 18C may have similar roles and duties within the each of the their respective business units 14A, 14B and 14C. Likewise, it will be appreciated that the accounting departments 20A, 20B, and 20C may have similar roles and duties within the each of the their respective business units 14A, 14B and 14C. Likewise, it will be appreciated that the marketing departments 22A, 22B, and 22C may have similar roles and duties within the each of the their respective business units 14A, 14B and 14C. Likewise, it will be appreciated that the IT departments 24A, 24B, and 24C may have similar roles and duties within the each of the their respective business units 14A, 14B and 14C. Likewise, it will be appreciated that the HR departments 26A, 26B, and 26C may have similar roles and duties within the each of the their respective business units 14A, 14B and 14C. Because of the similar roles and responsibilities of the similarly named departments of the business units 14A, 14B, and 14C, the present disclosure is able to increase collaboration and sharing between the departments of the business units 14A, 14B, and 14C in a manner that will now be explained. Indeed, the departments in different business units may have had little or no contact with each other when using previously available systems.

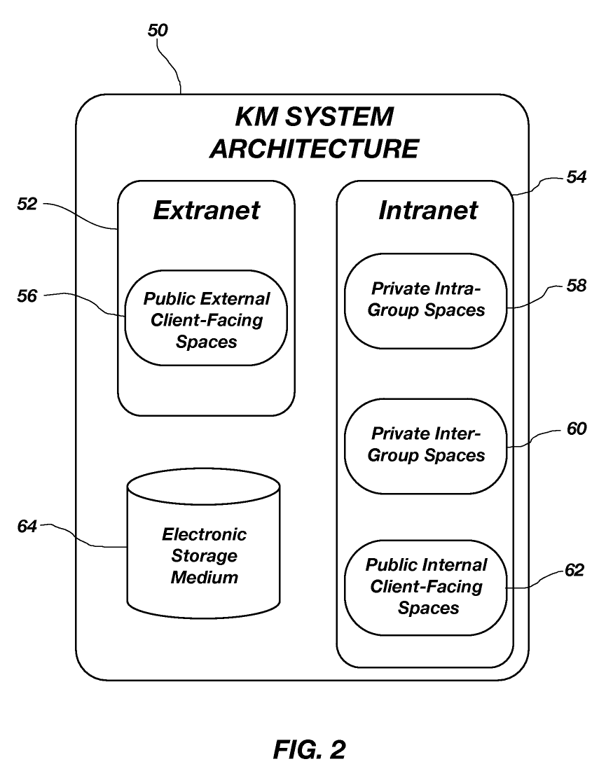

Referring now to FIG. 2, there is depicted a knowledge management system architecture 50 for structuring of information in a knowledge management system for the organization 10 (see FIG. 1) according to an embodiment of the present disclosure. The architecture 50 may comprise an extranet 52 and an intranet 54. It will be appreciated that as used herein, the concept of an intranet 54 refers to a private computer network that is contained within an organization. Typically, access to the intranet 54 is restricted to individuals within the organization. It will be further appreciated that the concept of the extranet 52 refers to a semi-private computer network of the organization 10 that is available to selected users outside of the organization 10, such as clients, suppliers, independent sales agents, dealers, business partners and others who do business with the organization 10. Both the intranet 54 and the extranet 52 may be hosted by one or more computer servers accessible from computer terminals located at the physical facilities of the organization 10 as is known to one having ordinary skill in the art. In addition, both the intranet 54 and the extranet 52 may be made accessible through a gateway to a third-party network, such as the Internet. Thus, restricted access to the intranet 54 and the extranet 52 may be accomplished from any computer connected to the Internet from any where in the world. Further, while the intranet 54 and extranet 52 may utilize proprietary protocols, the intranet 54 and the extranet 52 may also utilize standard internet protocols as is known to one having ordinary skill in the art.

The framework of the architecture 50 should support the different objectives of public spaces versus private spaces. A public space may refer to a space on a computer network that is designed to share information or services with others. For example, a public space may refer to a space that is accessible to the rest of the organization 10 or to others outside of the organization 10. A department of the organization 10, for example, may provide information or services to others within the organization or outside of the organization on a public space. A private space, on the other hand, is a space on a computer network that allows individuals having similar roles and responsibilities within the organization 10 to collaborate and share information amongst themselves.

Hosted on the extranet 52 may be one or more public external client-facing spaces 56. Hosted on the intranet 54 may be one or more private intra-group spaces 58, one or more private inter-group spaces 60, and one or more public internal client-facing spaces 62. Information hosted on the extranet 52 and the intranet 54 may be stored in an electronic storage medium 64 as is known to one having ordinary skill in the art. Each of these spaces 56, 58, 60 and 62 will now be described in more detail below.

The public external client-facing spaces 56 are preferably accessed through a standalone portal hosted on the extranet 52 for security reasons. Because the needs of the organization's 10 external clients are typically different from internal client needs, it is necessary to address these needs differently. There are preferably two areas of the portal for the public external client-facing spaces 56: One area devoted to specific client needs; and, Another a temporary area to host constantly changing information while collaborating with current or potential customers. The portal for the public external client-facing spaces 56 may be linked from the public internal client-facing spaces 62 and the private intra-group spaces 58 and the private inter-group spaces 60 in addition to being linked from a main web page of the organization 10 (see FIG. 1).

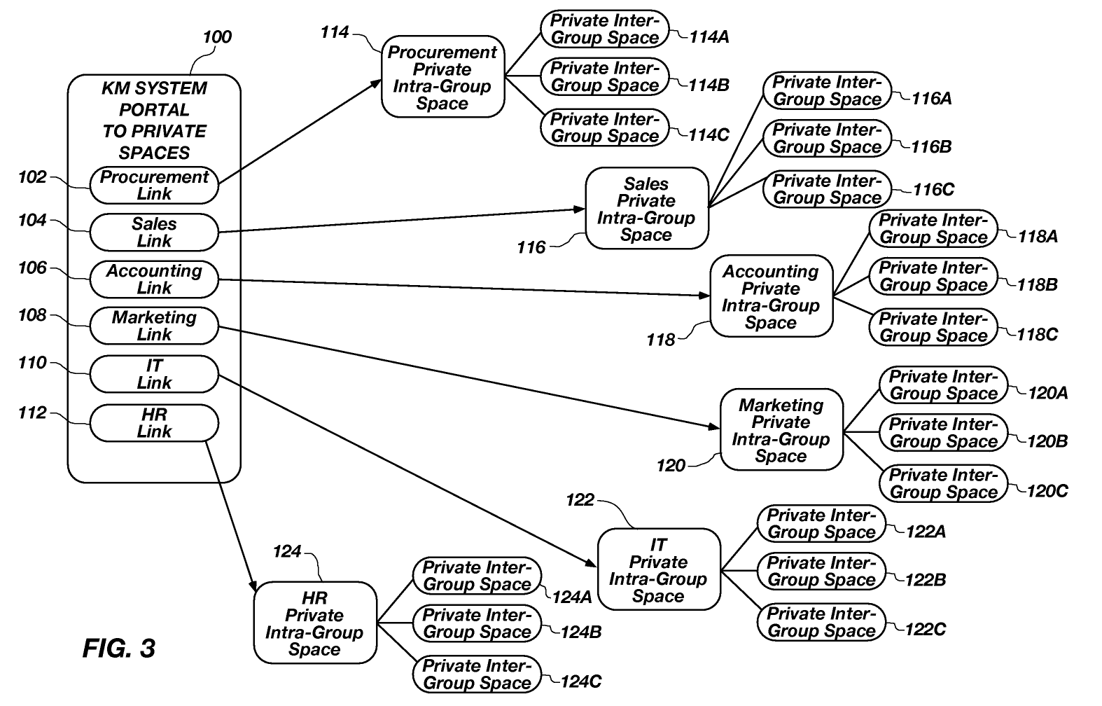

Referring now to FIG. 3, the private intra-group spaces 58 and the private inter-group spaces 60 for the organization 10 may be accessed through a portal 100 hosted on the intranet 54 (see FIG. 2). The portal 100 may include links to private intra-group spaces 58 (see FIG. 2) and private inter-group spaces 60 (see FIG. 2). Each of the departments of the organization 10 shown in FIG. 1 may have its own private inter-group space 60, while related departments across the business units 14A, 14B, and 14C (see FIG. 1) may have a private intra-group space 58. In particular, the portal 100 may include a procurement link 102 that leads to a procurement private intra-group space 114 which may only be accessible by members of the procurement departments 16A, 16B, and 16C in FIG. 1. The procurement private intra-group space 114 allows the members of the procurement departments 16A, 16B, and 16C in FIG. 1 to collaborate and share information as will be described in greater detail below. Further, the procurement private intra-group space 114 may provide links that lead to private inter-group spaces 114A, 114B, and 114C. The private inter-group spaces 114A, 114B, and 114C may be accessible only by members of the procurement departments 16A, 16B, and 16C, respectively. That is, only members of the procurement department 16A may access the private inter-group space 114A. Likewise, only members of the procurement department 16B may access the private inter-group space 114B and only members of the procurement department 16C may access the private inter-group space 114C. In this manner, members of the procurement departments 16A, 16B, and 16C may participate in both intra-group and inter-group collaborative efforts and sharing of information. The procurement departments 16A, 16B and 16C may therefore collectively form a collaborative group or team. It will be appreciated that the sales link 104, accounting link 106, marketing link 108, IT link 110, and the HR link 112 each lead to their own private intra-group and private inter-group spaces in a similar manner to the procurement link 102, and therefore will not be explained in further detail herein.

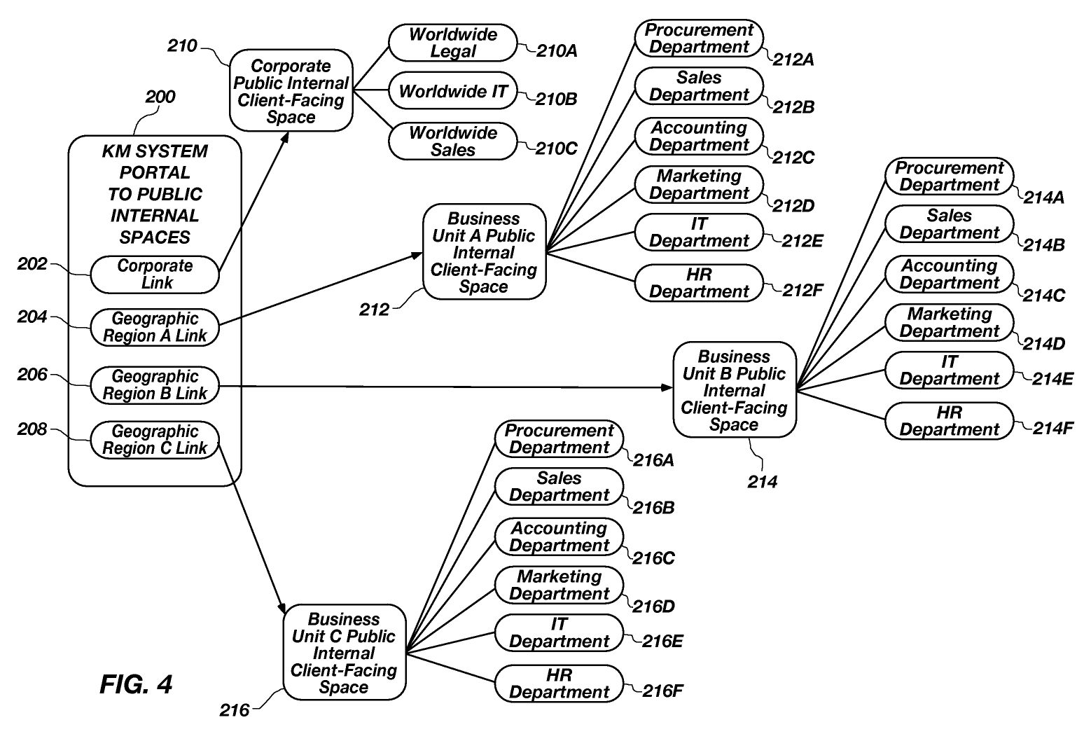

Referring now to FIG. 4, the public internal client-facing spaces 62 for the organization 10 (see FIG. 1) may be accessed through a portal 200 hosted on the intranet 54. Since the objective of the public internal client-facing spaces 62 is to share information with or for the rest of the organization 10, the architecture of the portal 200 may mirror the organizational structure of the organization 10 as shown in FIG. 1. Thus, the portal 200 may include a corporate link 202 that leads to a corporate public internal client-facing space 210. The corporate public internal client-facing space 210 may in turn provide links to corporate services spaces, such as worldwide legal department 210A, worldwide IT department 210B, and worldwide sales department 210C. The portal 200 may also provide links to each of the geographic regions, namely, Geographic Region A link 204, Geographic Region B link 206, and Geographic Region C link 208.

The Geographic Region A link 204 may lead to a business unit A public internal client-facing space 212. The space 212 may provide information about the services offered by business unit 14A shown in FIG. 1. Further, the space 212 may provide links to spaces of each of the departments associated with business unit 14A, namely a procurement department space 212A for the procurement department 16A (see FIG. 1), a sales department space 212B for the sales department 18A (see FIG. 1), an accounting department space 212C for the accounting department 20A (see FIG. 1), a marketing department space 212D for the marketing department 22A (see FIG. 1), an IT department space 212E for the IT department 24A (see FIG. 1) and an HR department space 212F for the HR department 26A (see FIG. 1). It will be appreciated that the links 206 and 208 for the Geographic Regions B and C, respectively, each lead to their own public internal client-facing spaces in a similar manner to the Geographic Region A link 204, and therefore will not be explained in further detail herein.

Having established the architecture 50 for a knowledge management system as described in relation to FIGS. 1-4, above, the manner of implementing the knowledge management system architecture 50 according to an embodiment of the present disclosure will now be described. In particular, the implementation process should attempt to centralize knowledge of the organization 10 using the architecture 50 to thereby reduce duplication of content, streamline maintenance processes, and allow knowledge within the organization 10 to be shared across all of the business units 14A, 14B, and 14C instead of localizing the knowledge in each of their respective departments.

The implementation process of the present disclosure should allow elimination of localized knowledge stored in email systems, personal network or local memory devices, and migrate this information to shared public and private spaces of the architecture 50 (see FIG. 2). The implementation process should further attempt to make the knowledge of the organization 10 as accessible as possible to the appropriate people using the architecture 50. The implementation process should further attempt to make the knowledge of the organization 10 as accurate as possible using the architecture 50. The implementation process should further attempt to make the knowledge of the organization 10 available using either push technology or pull technology to the appropriate people using the architecture 50.

The implementation process should further provide the ability to individuals to collaborate on knowledge and innovate to develop best practices using the architecture 50. The implementation process should further secure and protect the knowledge of the organization 10 using the architecture 50.

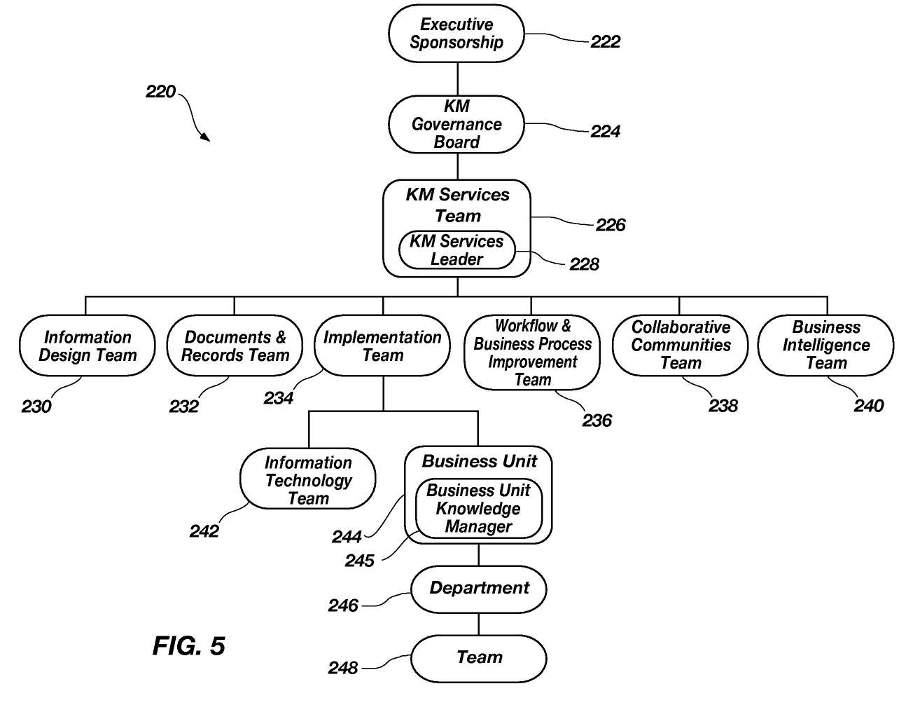

Referring now to FIG. 5, there is depicted a model of an organizational structure 220 suitable for implementing the knowledge management system architecture 50 with respect to the organization 10 pursuant to an embodiment of the present disclosure. The organizational structure 220 may be implemented within the organization 10 itself. The organizational structure 220 is best adapted for use within a large business entity, but it will be appreciated by those having skill in the art that the organizational structure 220 may be adapted for use in any organization, including governmental entities, religious organizations, non-profit entities, small businesses and the like. The organizational structure 220 should typically be implemented on an organization-wide basis and not reside in any current existing business unit or department of the organization 10.

Key to implementing the knowledge management architecture 50 pursuant to an embodiment of the present disclosure is executive sponsorship 222. Typically, at least one senior-level executive within the organization 10 will be tasked with implementing knowledge management as described herein. This senior-level executive should be close to the head of the organization, such as a CEO, in the chain of command of the organization 10. The responsibilities of this new executive role may include the following:
Providing or approving the overall knowledge management strategy and vision.
Attending knowledge management governance board 224 (steering committee) meetings monthly in the beginning stages of the knowledge management program and then quarterly or at the least every six months when the knowledge management program is well-established.
Be available for the knowledge management services team 226 for immediate guidance if necessary.
Remove any roadblocks that have been escalated up from the knowledge management governing board 224 or the knowledge management service team 226.

Below the executive sponsorship 222 may be the knowledge management governance board 224, which is comprised of senior-level management and that can represent each business unit or region and is responsible for overall program development, oversight, and effectiveness. It is important that this board 224 have senior-level management who have the authority to make financial, resource, and strategic decisions for the organization and who have the power to remove roadblocks from any level of the organization. The responsibilities of the knowledge management governance board 224 may include:
Attending knowledge management governance board 224 meetings monthly in the beginning stages of the knowledge management program and then quarterly or at the least every six months when the knowledge management program is well-established.
Prioritize the list of business units, departments or teams at the organization 10 for the knowledge management services team 226 based on the extent their knowledge management issues impact critical business operations or success and what makes sense for the organization strategically.
Decide which knowledge management metrics the knowledge management services team 226 should measure or capture at the knowledge management project and knowledge management program level since there are so many knowledge management metrics that an organization can measure but not all may make sense or be worth measuring for the organization.
Review knowledge management project status and metrics and knowledge management program metrics, discuss any issues, and make decisions for correction or improvement.
Review and approve plans for a global intranet site and any content or usage ideas for the global and regional portals submitted to the knowledge management services team 226 by anyone at the organization.

Directly below the board 224 may be the knowledge management services team 226. This knowledge management service team 226 may work directly with other business units, teams, departments and individuals within the organization. The responsibilities of the knowledge management services team 226 may include:
Providing consulting services to business units, departments or teams by applying the methodology of the present disclosure. This engagement is referred to as a knowledge management project with its own project charter and metrics to measure issues and success. It may also result in configuration and/or customization of their site to best support their workflow and processes.
Train and certify business unit knowledge managers 245 in knowledge management best practices so they can successfully maintain the knowledge management solution as described herein and help enforce knowledge management best practices on a day-to-day basis.
For the first three months after the implementation of a knowledge management solution according to the present disclosure of the knowledge management project for the business unit, department or team, meet with business unit knowledge managers 245 monthly to review status, evaluate solution and progress, and address any issues or concerns. Meet quarterly after the first three months to do the same and also to share any new best practices and provide additional knowledge management services if a business unit, department or team has new processes or have significantly changed their processes.
Maintain a worldwide knowledge management services intranet site and ensure that all policies, procedures, and related communications and best practices are current and easily accessible through the site. The site preferably models and is an example of best practices that others should follow.
Compile and provide status reports and metrics on knowledge management projects and knowledge management program progress for the knowledge management governance board to review.
Meet monthly with the knowledge governance board 224 in the beginning stages of the knowledge management program and then quarterly thereafter to provide information, seek guidance, and submit for review content or usage ideas or improvements for the global and regional intranet portals including improvements to its taxonomy or data classification system and opportunities to standardize processes between business units, departments or teams and to create communities of practice, learning communities, project communities, and affinity networks.
Provide third-level support for end-users of knowledge management system if questions are about how to use or do something in/with knowledge management system.

The knowledge management services team 226 may include a knowledge management services leader 228. The goal of the leader 228 of the knowledge management services team 226 is to plan, strategize, and work with key stakeholders to obtain buy-in for the knowledge management initiative and promote the cultural change needed for successful knowledge management implementation and adoption across the organization. Once the foundation of knowledge management is successfully established across the organization, the leader 228 will be responsible for maintaining, adapting, and applying the knowledge management system/methodology as business processes, groups, and information change over time. Major responsibilities of the knowledge management services leader 228 may include the following:
Educating key stakeholders of the value of knowledge management.
Promoting knowledge management to all impacted associates.
Obtaining the resources necessary to support knowledge management.
Updating knowledge management strategy and methodology as needed and keeping current.

The organization 10 implementing the principles of the present disclosure may establish an information design team 230 under the knowledge management services team 226. The goal of an information design team 230 is to identify, capture, standardize, and codify organizational knowledge for the purpose of sharing knowledge and expertise through the knowledge management system. The information design team 230 may be responsible for the standardization of information presentation, improving the design of existing documents and web content, and capturing (documenting) critical “tribal” knowledge. Information design skills and interviewing skills are preferably required for the members of the information design team 230. These skills address the issues of poor documentation and lack of documentation (“tribal” knowledge). Major responsibilities of the information design team 230 within the organizational structure 220 may include the following:
Promote the importance of information design to reduce any resistance to improving the quality of existing and new documentation.
Review and improve the quality of existing documentation and web content.
Interview Subject Matter Experts for critical tribal knowledge.
Engage the workflow and business process improvement person to analyze data from interviews, research best practices, standardize process, and obtain a consensus on standard processes.
Document process details and create supporting documentation, web pages, templates, or forms when standard process is approved.
Work with documents/records managers and business units 244 to determine the appropriate taxonomy (how information will be categorized and codified) in the knowledge management site or portal.
As business processes change or new best practices are identified, the business processes or best practices may change. As a result, information designers will provide ongoing information design support as needed.
Design and develop any documentation or any web pages needed to support a collaborative community (e.g., instant messaging, chat rooms, discussion boards, e-mail, web collaboration tool, community guidelines, rules of engagement, marketing material, roles and responsibilities).

The organization 10 implementing the present disclosure may establish a documents and records team 232 (still referring to FIG. 5) who is responsible for the organization, classification, retention and retrieval of documents (in-process) and records (final). The documents and records team 232 may be under the knowledge services team 226 in the organizational structure 220. The individuals in the documents and records team 232 may be certified in records management by a third-party entity, such as the Institute for Certified Records Managers. The responsibilities of the documents and records team 232 address the issues of duplication of content, records retention, outdated and hard to find content. Major responsibilities of the documents and records team 232 may include:
Develop, update, communicate, and implement Document Management & Records Management (DM/RM) policies and procedures, including a process-based methodology for managing records retention schedules (including e-mails), to meet domestic and international business and legal requirements and enhance efficiency.
Communicate the value of DM/RM and promote effective standards and practices.
Maintain awareness of trends, technological solutions for the management, storage, access, retention and destruction of electronic and paper-based records, practices and issues in DM/RM.
Partner with the organizations's disaster recovery group (Business Continuity Team) to develop appropriate disaster protection and recovery methods for vital company records.
Manage the placement of company records into storage and retrieval from storage, including e-records contained in Enterprise Content Management (ECM) systems.
Assess and deliver activity and statistical reports, as required, for all aspects of the DM/RM program.
Establish accountability and ownership of records in e-format.
Develop, implement, and monitor ongoing DM/RM training programs for associates.
Consult with internal groups on DM/RM issues to meet business and compliance requirements.
Participate in the evaluation and recommendation of systems, applications, media format and storage requirements to be used throughout the DM/RM lifecycle.

The organization 10 implementing the present disclosure may establish an implementation team 234 under the knowledge management services team 226 in the organizational structure 220. The implementation team 234 may be responsible for managing the implementation of the knowledge management solution for a business unit of the organization 10, providing knowledge management consulting, working with a business unit 244 to determine the different components or functionality of the business unit's knowledge management solution, pulling in expertise when needed, and training the business unit knowledge managers 245 on maintaining the knowledge management solution. The business unit 244 may comprise a department 246, which in turn may comprise a team 248.

It will be appreciated that while only one business unit 244 is depicted in FIG. 5, that the organizational structure 220 may be adapted to work with the plurality of business units 14A, 14B and 14C of the organization 10 (see FIG. 1). It will be further appreciated that while only one department 246 is depicted under the business unit 244, that a plurality of departments 246 may be formed under each business unit 244, such as with business units 14A, 14B, and 14C of the organization 10 (see FIG. 1). It will be further appreciated that while only one team 248 is depicted under the department 246, that a plurality of teams 248 may be formed under each department 246. In an embodiment of the present disclosure, each business unit 244 may be responsible for a significant function within the overall business and has a significant degree of autonomy and responsibility.

The implementation team 234 (still referring to FIG. 5) also interfaces with IT liaisons from an information technology 242 to ensure knowledge management is appropriately involved in IT projects or initiatives that may impact or support knowledge management. Consulting, project management and training skills are also required for the implementation team 234. The implementation team 234 may address the issues of change management and end-user adoption.

The business unit knowledge manager 245 may report to the various business units 244, departments 246 or teams 248 at the organization 10 and may also report to the knowledge management services team 226. This will ensure business ownership of the solution as well as provide closer “eyes and ears” supervision of the business unit 244 for effective monitoring and adoption. Some business unit knowledge managers 245 may allocate a percentage of their time to the knowledge management services team 226 to provide expertise in any of the above roles in addition to their business unit 244 responsibilities. The business unit knowledge manager 245 should be an existing associate in the business unit 244 and ideally already managing or overseeing the current information system of the unit 244 (e.g., PEOPLESOFT® for HR, MATTER MANAGEMENT™ for Legal, SITEADMINISTRATOR® for an intranet site). This means that the business unit knowledge manager 245 will already have a full-time job and the new responsibilities under organizational structure 220 will be in addition to his or her current responsibilities.

In most cases, the role of the business unit knowledge manager 245 can be performed on a part-time basis. However, in large business units 244, it may be necessary to devote someone full-time to this role. The premise is that knowledge management would create so many efficiencies that an organization is able to dedicate full-time resources or part-time resources to the knowledge management effort on a permanent basis without having to add additional headcount to the company's bottom line reallocating percentages of current resources). Major responsibilities of the business unit knowledge manager 245 under the organizational structure 220 may include:
Serves as knowledge management system administrator (including user security, system updates and conversions, troubleshooting and testing) for the business unit 244 and manages site and content administrators for business unit's 244 public and private intranet sites to ensure knowledge management best practices are appropriately applied and maintained.
Manages content publishing process.
Monitors and encourages knowledge management best practices the implementation team 234 has agreed to implement.
Conducts training for the business unit 244 and/or cross-functional team members as needed.
Those with developer level skills will support the knowledge management services team 226 if extensive configuration and/or customization are needed.
Act as first-level support for their business unit 244 by responding to support questions, bugs, and other problems requiring issue resolution.

Act as a part of a support and developer community (second-level support) with varying degrees of proficiency in software development. Members can range from highly skilled programmers who can customize the solution, technically savvy end users who can configure the solution, or administrators who are in charge of maintaining the solution and enforcing knowledge management best practices. Skilled developers will handle large change requests, new features, and program management while ensuring adherence to standards.
Coordinates with departing associates in the unit to determine the status of their active and inactive content. Ensures active content is transitioned.
Conducts complex searches to retrieve information from a variety of sources, electronic and manual, to support unit projects and goals.
Support the migration of critical legacy systems to the new knowledge management system.

The organization 10 implementing the present disclosure may establish a workflow and business process improvements team 236 under the knowledge management services team 226 in the organizational structure 220. The goal of the workflow and business process improvements team 236 is to examine existing business processes within or across business units or teams, researching best practices within and outside the organization, performing SIX SIGMA® or other types of root cause analyses to fix or improve broken processes, standardize processes, and develop workflow solutions to automate them. Knowledge of workflow and business process improvement tools is required as well as experience in business process improvement and management (e.g., ISO®, SIX SIGMA, GREEN BELT™) for participation on the workflow and business process improvements team 236.

The organization 10 implementing the present disclosure may establish a collaborative communities team 238 under the knowledge management services team 226 in the organizational structure 220. The goal of the collaborative communities team 238 is to identify and bring together groups of associates with similar knowledge and business objectives for the purpose of collaboration to facilitate the sharing of expertise, foster innovation, and develop best practices which can then be captured and codified by an information designer to be shared through a dedicated knowledge management system.

The collaborative communities team 238 is further responsible for examining communication and collaboration opportunities between individuals within teams and across teams and other organizational boundaries in order to best support and enable innovation to occur. Knowledge of communication and collaboration tools are required as well as experience social network analysis, expert identification, and building communities of practice, learning communities, project communities, and affinity networks for individuals on the collaborative communities team 238. The collaborative communities team 238 will also address the issues of duplication of effort, silos, untapped knowledge, talent and experience, productivity, efficiency, innovation, sharing of best practices. Major responsibilities of the collaborative communities team 238 may include the following:
Conduct social network analysis to identify who's who in the organization, including key connectors and isolates within the organization. Group associates with similar knowledge, background and skills together to form Learning Communities and Affinity Networks. Group associates working on similar projects or have similar responsibilities together to form Project Communities and Communities of Practice.
Clearly identify all members of the community or network with an adequate amount of information regarding their background, skills, knowledge, expertise, project responsibilities, or job responsibilities.
Obtain executive level or senior management level support and encouragement for the community to increase awareness and usage and add value and importance to the role of community.
Educate senior management about the importance of not criticizing members for sharing their ideas or thoughts in the community. Emphasis should be placed instead on the value of brainstorming, experimenting, testing, and appropriate risk tasking. Acknowledge that failure is a sometimes an unavoidable part of the process, that sometimes mistakes can be the greatest learning tool and that bad ideas may be the only way to identify good ideas.
Educate members of the value of the community to them, the benefits of using the community, and how they can use it to their advantage. Highlight the special purpose of the community and the common interests or goals the members share with each other. Work with members to brand it, involve them in the naming of the community, designing the look and feel, and establishing the basic ground rules of conduct for the community.
Identify a member or several members who can manage the community (e.g., hold elections for community officers, define their roles and responsibilities, etc.) and insure that key connectors play a major role in the community either as community leaders or other major roles.
Set up and configure the community or network web site or portal to best support the community.
Provide members information (materials or training developed by the information design team 230) on how they can access the community through the knowledge management system and how to use the collaboration tools provided by the knowledge management system (i.e., instant messaging, chat rooms, discussion boards, e-mail, web collaboration tool).
Design and develop a method or process of capturing best practices that evolve from communities or networks to input into the knowledge management system.
If the cultural environment does not support the values of a collaborative community, implement a process of change management to break old habits and encourage new ones.

The organization 10 implementing the present disclosure may establish a business intelligence team 240 (still referring to FIG. 5) that is responsible for reporting and conducting an analysis of information to support decision-making. Knowledge of data mining, measurement, balanced scorecards, and dashboard tools and technologies are generally required for participation on the business intelligence team 240. The business intelligence team 240 may address the issues of responding to rapidly changing market conditions, making informed decisions and using knowledge management to run the business.

It will be noted that an organization, such as a business entity, may have multiple business units with similar organizational structures located in different geographic regions of the world. For example, a global business may have a North American business unit, a Central and South American business unit, a European business unit and an Asian business unit. Each of these business units may all have the same or similar organizational structures. For example, each business unit may have a procurement department, a sales department, an accounting department, marketing department, an IT department and an HR department. It will be appreciated that similarly named departments across the different business units may have the same duties and roles within their respective business units.

Once the organizational structure 220 shown in FIG. 5 is organized and established within the organization 10, the process of codifying the information of the organization 10 into the architecture 50 (see FIG. 2) can begin as will now be described. As discussed above, the implementation team 234 is primarily responsible in helping determine the content that should be codified and where in the architecture 50 it should be placed. It will be appreciated that since there is typically too much information and everyone has their own opinion as to what information is important, the present disclosure provides a method of prioritizing the content that needs to be captured and codified. The present disclosure further provides where the content should be placed in the architecture 50. In particular, the present disclosure captures and codifies only knowledge and information that is needed to support critical or key business processes but other knowledge and information may also be captured and codified in accordance with the principles of the present disclosure will be appreciated by those skilled in the art. As will be explained in more detail hereinafter, each business unit or department may need to define and decide what its key business processes are. Further, if the content is to be posted on public client-facing spaces 56 and 62 (see FIG. 2), client focus groups may need to be conducted to ensure that the content meets the needs of the target audience.

Publishing content for public client-facing spaces 56 and 62 (see FIG. 2) is preferably restricted to the business unit knowledge manager 245 (see FIG. 5) in order to avoid the problems that arise when many people are given the ability to publish content to the knowledge management architecture 50. The content is preferably also initially reviewed by an information designer from the information design team 230 to ensure the content is designed well. The ability to publish content for private spaces 58 and 60 (see FIG. 2) is preferably open to everyone in the group who will need to contribute knowledge and information to the site for the purpose of communication and collaboration. However, the business unit knowledge manager 245 preferably monitors and controls the content to ensure best practices.

Knowledge may be classified into a variety of categories by the business unit 244 using that knowledge together with help of the document and records team 232 whose area of expertise is information metadata, classification, taxonomy and retrieval. The organizational structure of that knowledge is preferably flexible enough to meet the changing needs of the organization 10 but with long-term use in mind so that it does not need to be changed often. An effective approach is to auto-populate many of the required classifications based on the role of the person placing the content into the architecture 50 and where they are placing it. This encourages end user adoption because it does not require extra work on their behalf and it allows for robust searching capabilities.

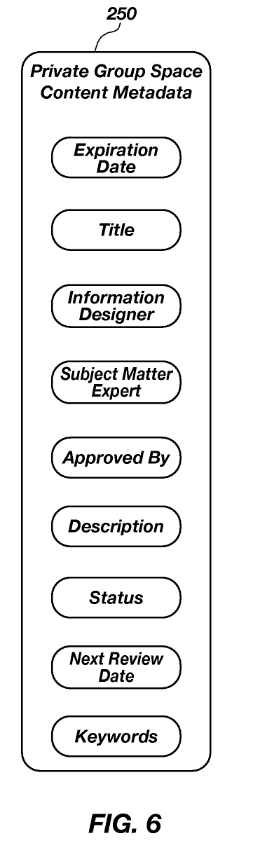

Referring now to FIG. 6, there is depicted a diagram indicating metadata tags for each piece of information, including documents, that is stored in the intra-group and inter-group private spaces 58 and 60 (see FIG. 2). In particular, each piece of information/document that is stored in a private team space is preferably meta-tagged with the following information:
Expiration Date—The architecture 50 may provide the ability to attach expiration dates to its content so that the items that have expired will automatically remove themselves from the space or automatically alert a subject matter expert for the content to update it. Even though expired, the content still exists in the framework but can be hidden in the background. It will be appreciated that this will help prevent the spaces of the framework from displaying outdated information and therefore keep users coming to the space as well as help keep the content updated via automatic reminders and notifications.
Title—Title or descriptive name of the document or information.
Information Designer—The identity of the person who chooses the format of the document and writes the document. This addresses the issue of documents not being well-written, formatted, or organized.
SME (Subject Matter Expert)—The identity of the person who is considered the subject expert/authority in the organization 10 to provide the content of the document or information. This point addresses the issue of inaccurate, misleading, or inadequate content.

Approved By (Manager)—The identity of the person who is ultimately responsible for the content. This addresses the issue of inappropriate or irrelevant content.
Description—Provides more detail about the purpose and content of the document or information. This helps provide a more powerful search capability.
Status—Completion status of document (e.g., in review or final). This will addresses the issue of document versioning, control and management.
Next Review Date—Identifies the date when the content should be reviewed for outdated information and be updated and re-posted. This point addresses the issue of outdated information.
Keywords—Additional words that end-users might use to refer to content. This point will enhance the accuracy of a search engine.

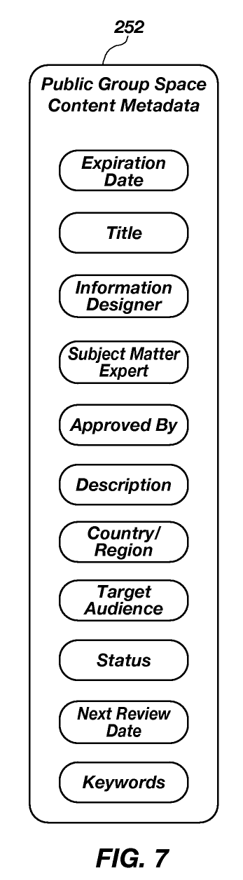

Referring now to FIG. 7, there is depicted a diagram indicating metadata tags for each piece of information, including documents, that is stored in the internal and external public facing spaces 56 and 62 (see FIG. 2). In particular, each piece of information/document that is stored in a public facing space is preferably meta-tagged with the same information for the private group spaces discussed above, including the following additional information:
Country/Region—Identifies the country or region that the content is for.
Target Audience—Identifies the specific audience or type of associate the content is for (e.g., Santa Ana or Buffalo, or managers or hourly associates).

The architecture 50 may also further provide the option to differentiate between official knowledge or information (records) and unofficial knowledge or information (documents). Official knowledge or information refers to information that does not change often, or information that should be final or agreed upon by all affected parties. Write-access to official knowledge should be restricted to those given the responsibility for managing the posting of official knowledge. Others can open and read the knowledge, but they cannot change it. Others can also make a copy of official knowledge (records) and alter it but it should not be considered official knowledge until it is approved to be placed in the official knowledge area. The ability to create subfolders or rename folders is also restricted to only those responsible for managing the posting of documents to this area. How the official knowledge folders should be named or categorized is preferably agreed upon by every member of the group that is using that shared space.

Unofficial knowledge or information includes in-progress information, a “sandbox” area where information changes often due to collaborating, updates, draft stages of documents, testing out of new ideas/versions, etc. Unofficial knowledge or information may be accessible by all and everyone in the group preferably is able to create folders and subfolders as needed.

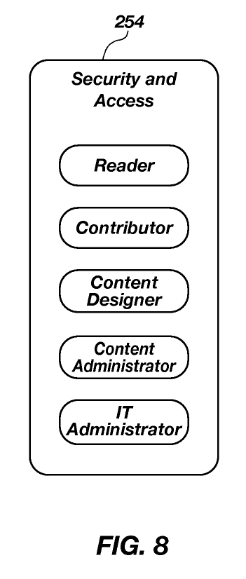

Referring now to FIG. 8, there is shown a diagram 254 depicting security and access for the architecture 50 (see FIG. 2). In particular, determining who has permission to access content in the architecture 50 may be determined by the business unit 244 (see FIG. 5). The following is a list of standard access levels which a knowledge management system may have:

Reader—read-only access.

Contributor—able to add new items to existing web parts and edit items in existing web parts.

Content Designer—able to add new web parts or sub-sites and change web part or sub-site settings and design.

Content Administrator—able to do all of the above and grant user access, change permissions, and delete sub-sites.

IT Administrator—able to do all of the above but focuses on the technology requirements of the solution.

For the private group spaces 58 and 60, the content administrator access should be given to only the group's business unit knowledge manager 245 and corresponding knowledge management implementation manager, and a few, if any, given content designer access. All others should be given contributor access and maybe some with only reader access.

For public client-facing spaces 56 and 62, only the business unit knowledge manager 245 and knowledge management implementation manager may be given content administrator access. Some can be given content designer access if the team or department is large in order to help maintain the public client-facing space. Everyone else at the organization is preferably given only reader access.

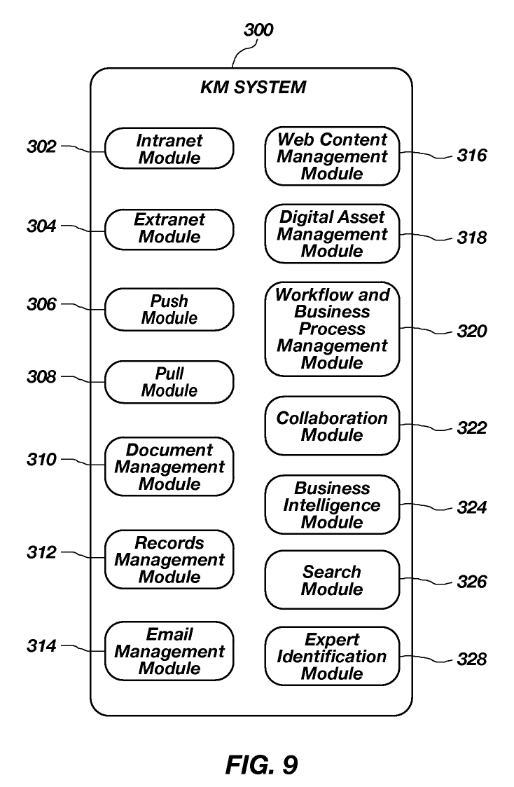

Referring now to FIG. 9, there is depicted a diagram of a knowledge management system 300 pursuant to an embodiment of the present disclosure. The system 300 may comprise an intranet module 302. The intranet module 302 may provide a private computer network for the organization 10 (see FIG. 1) as is will now be known to one having ordinary skill in the art. The intranet module 302 may comprise one or more servers connected to a plurality of computer terminals over a private computer network within the organization 10. The system 300 may further comprise an extranet module 304. The extranet module 304 may further provide third-party access to a private network of the organization 10. The extranet module 304 may be stand alone from the intranet module 302 for security reasons.

Both the intranet module 302 and the extranet module 304 may host information as described herein. In particular, the intranet module 302 may host the private intra-group spaces 58, the private inter-group spaces 60, and the public internal client-facing spaces 62 (see FIG. 2). The public external client-facing spaces 56 (see FIG. 2) may be hosted by the extranet module 52.

Both the intranet module 302 and the extranet module 304 may utilize portals. As used herein, the concept of a portal may refer to a website that is used as an entry point to other websites, often by being or providing access to a search engine. Portals may also house general content as well but is not designed to display a lot of the content itself. There should be portals for public spaces 56 and 62 and portals for the private spaces 58 and 60.

The public internal client-facing portals preferably have standard announcements, discussion boards, and document library web parts on the portal home page as well as links to country sites and regional department sites. Communications from the organization 10 can use the announcement web part instead of sending an e-mail to all associates worldwide or within a region for one-way communications. This will centralize the content of the communication and associates can receive an alert e-mail pointing to the content on the site. This will reduce unnecessary duplication of content on e-mail servers and eliminate the need to manage the e-mail (i.e., determining whether to keep the e-mail or where to file the e-mail) since the e-mail does not contain content and therefore can just be deleted.

Discussion boards on public client-facing portals can be used to open up lines of communication among all associates at an organization or in a particular region that they never had before since e-mailing all associates at the organization or all associates in a region for two-way communication is prohibited. Document libraries provide a technique to share documents globally and regionally without having to e-mail copies of documents back and forth. This will drastically reduce the number of duplicate documents, reduce the load on e-mail servers, prevent mailboxes from reaching their maximum capacity and reduce e-mail server capacity and storage issues. The knowledge management function can provide knowledge management consulting services to ensure these sites are set up to meet the site's objectives and employ effective knowledge management best practices and information design principles to maximize search capabilities, comprehension, and utilization of the content on the sites.

As private spaces or sites are created, they are preferably tagged with a department name (or marked as “All” if cross-functional) and region. These tags preferably automatically categorize them into the site directory menus for easy classification, grouping and searching. Private spaces or sites can be configured to meet the needs of the team or the objectives of the site. The knowledge management function can provide knowledge management consulting services to ensure these sites are set up to meet their objectives, support the teams critical business processes, and employ effective knowledge management best practices and information design principles. The benefits of portal usage may include: increased awareness of different departments and business units, increased sense of community and open communication, reduced search time for information, increased associate productivity, better decision-making, reduced need for training and reduced need to bother busy associates for standard information.

The system 300 (still referring to FIG. 9) may further comprise a push module 306. The push module 306 may automatically push information to a user or filtered based on a user's profile such as their job title, role, responsibilities, team, department, projects they are working on, etc. This is referred to as “push” technology or “role-based” personalization.

The system 300 may further comprise a pull module 308. The pull module 308 is operable to show only certain content or hide certain content from a user's personal space. This is referred to as “pull” technology. The “pulled” content is dynamic and automatically updated. Expired content automatically disappears from a user's personal space. Another example of “pull” technology is an effective and efficient search engine that can search text in documents, text in attachments, content metadata, content classifications, and automatically relate keywords to synonyms, perform a percentage match, and allow users to define their own preferred keywords.

The system 300 may further include a document management module 310. A document may be further defined herein as “recorded information or object which can be treated as a unit.” It is further defined as a work-in-progress. It is something that is being created and modified until it becomes a record. Document management is the set of practices, tools, and technologies that allow documents to be created, modified, finalized, classified and tagged with metadata. Features of the document management module 310 may include:
Document libraries—Centralized repositories for documents. One working version should be active and all previous versions should be inactive but available for viewing.
Document Workspaces—Document workspaces can be used to separate official final documents from unofficial in-progress documents since they are designed to manage and track the development of documents. Document workspaces are sub-sites that are dedicated to the development of documents.
Check In/Out—Checking in and out a document prevents others from editing that document while you are editing the document. This point also lets others know that you have the document for editing. This point also prevents different conflicting edits of the same document and allows others to see changes made to a document before making their own changes to the document. When a document is checked back in, there is an opportunity to attach comments to the document specifying what was changed in the document so others can see a revision history of the document.
Automatic Versioning—With automatic versioning, a new version of the document will automatically be created and displayed as the most recent version each time the document is edited and saved. By default, only the last version is displayed in the document library. However, the user can switch back to an earlier version by looking at the version history log and restoring an earlier version thereby making it the latest version that is displayed by default. This point allows multiple versions of the document to be stored and tracked in case there are disagreements or changes in the business situation which would warrant going back to earlier versions. This could also be used to satisfy legal requirements such as keeping all versions of policies or contracts.
Metadata—Metadata is data about data or content. Quality metadata can significantly enhance the search engine as well as provides various techniques to categorize documents.
Audit Trail—In the background, the tool used to implement this point should record a specified set of pre-determined information needed for the purpose of auditing. The audit trail should be capable of self deleting after specified time lapses based on compliance and/or business unit need.
Review and Approval—The ability to submit for review and approval and be linked to the Workflow tool.
Declaration as a Record—The ability to mark a completed document as a record, which should initiate a process for placing it in the most appropriate records repository and closing out the document workspace or library it was originally housed in.

It will be appreciated that the benefits of the document management module 310 may include: reduced data storage costs, proficiency gains on the network, improved employee productivity and reduced litigation costs.

The system 300 (still referring to FIG. 9) may further include a records management module 312. A “record” is defined as a final version of a document. Most documents become records when they are in their final form. However, there is a difference between a critical record and a non-critical record. A critical record is a final version of a document that is required for one or more of the following reasons:
As proof of a organization decision.
For organization continuity.
For legal or compliance reasons.

A non-critical record is a record that does not meet the above-listed requirements. “Records management” is the methods, tools and technologies used to manage the records of an organization (such as organization 10 in FIG. 1). A records retention policy is a document that governs the records retention schedule. The records retention schedule is a list of record types and how long they should be kept. The features of a records management module 312 may include:
Records Repositories—Central repositories for official knowledge to be placed, managed, and disposed of.
Paper & Electronic—Records Repositories should allow for both electronic-only records and paper records. Physical file location should be addressed when records are in physical form only or are in hybrid form (paper & digital).
Expiration Date (Up for review date)—Records should be reviewed periodically to ensure there is still a need for the record, which should be guided by the Records Retention Policy and Schedule.
Disposition—Identify whether the record is active and current, or is archived or is destroyed.
Records Hold—Apply a company-wide records hold on documents and records when a request has been made by a court or government agency.
Destruction Audit Trail—When records are destroyed, an audit trail of basic information is preferably left behind. It could include certain metadata, classification and the retention policy and schedule which guided the destruction of the records.

It will be appreciated that the benefits of records management module 312 may include: reduced data storage costs, proficiency gains on the network, improved employee productivity and reduced litigation costs.

The system 300 may further include an email management module 314. Email can be considered both a document and a record, but since it poses such a significant challenge to organizations today, it deserves its own definitions and discussion. Email Management tools should allow an organization to easily receive, filter, categorize, disseminate, retain or delete emails. These tools can take the decision-making of how and where to manage email out of the hands of individual associates and apply a company-wide standard that can protect the company and increase associate productivity. The features of an email management module 314 may include:
Email Repositories—Centralized storage for emails based on the documents and records they are related to. Having emails be placed in the same folder structure as the work they are related to is a key feature of Email Management.
Native in OUTLOOK®—The Email Management tool preferably makes the Document Management and Records Management tools appear as if they were in Outlook. The role-based filing structure should appear in Outlook so that users can place emails in the appropriate library or repository and therefore take it out of the email server and private/network file storage systems.
Drag-n-Drop—Users preferably are able to drag and drop email and attachments into the appropriate files and folders.
Ediscovery—The tool preferably allows for the Legal Department's Paralegal to search, analyze and produce emails when required to by courts or government agencies.

It will be appreciated that the benefits of email management module 314 may include: reduced data storage costs, proficiency gains on the network, increased associate productivity, increased visibility, reduced duplication of effort and decreased litigation costs.

The system 300 may further include a web content management module 316. Web content can be defined as both documents and records. The web content management module 316 includes the methods, tools and technologies used to author, publish, maintain, and retain or destroy web content according to a records retention schedule. Determining how content should be managed, maintained, and updated depends upon the type of content and how it is used. It also depends on the features and capabilities of the knowledge management system 300. For each portal or particular space, a content maintenance plan should be drafted to ensure ongoing maintenance and usage of the content. The knowledge management services team 226 (see FIG. 5) can help draft this plan based on the needs of the business and knowledge management best practices. Relevant features of a web management module 316 may include:
Content Creation—Allows a content author to create content within the web content management solution and decide where it best fits in the overall design of the space.
Content Submission—Content authors can submit content for approval and placement on the space.
Content Approval—The content approval feature allows users with contributor access to add content to a web part on a site but the content will not be visible to everyone until the designated content approver (i.e., the knowledge manager) approves the content. This will help prevent misleading, inappropriate, or poorly designed content from being posted.
Content Publication—The business unit knowledge manager (224 in FIG. 9) can approve the content and this approval will automatically push the content to appropriate space.
Edit & Reorganize—Content authors and business unit knowledge managers 245 can edit and reorganize content with the approval of the knowledge management services team 226.
Apply Retention Schedule—Established retention schedules should be applied to content to push it for review, renewal or destruction.

It will be appreciated that the benefits of the web content management module 316 may include: reduced search time for information; increased associate productivity; better decision-making; reduced need for training; and, reduced need to bother busy associates for standard information.

The system 300 may further include a digital asset management module 318. Digital assets are defined as information that is not text-based and primarily includes images, video, audio and other non-textual information. Digital assets require a little more metadata and classification than a document in order to be searchable by a search tool. Relevant features of a digital asset management module 318 may include:
Digital Asset Repositories—Centralized repositories where digital assets are to be placed.
Metadata—More metadata fields are required because the information is not text-based and therefore needs more information to be searchable.
Declaration as a Record—The ability to mark a completed digital asset as a record.

The benefits of a digital asset management module 318 may include: increased associate productivity and increased information reuse.

The system 300 may further include a workflow and business process management module 320. Business processes exist whether they are documented or not. Business process management is the documentation and improvement of existing processes. Workflow is a set of tools and technologies used to automate certain aspects of business process management. The ability to create interactive forms that can dynamically change in response to user input and can be automatically routed to different people for approval or additional input is one example of workflow that would be useful at an organization. Relevant features of the workflow and business process management module 320 may include:
Standard Workflows—The workflow tool should include pre-defined standard workflows, which can be configured with a GUI-based Workflow creation tool.
Complex Workflows—Ability to create, edit and delete complex workflows, preferably in a GUI-based environment.
Parallel Execution—Preferably able to allow for parallel execution of tasks in a workflow in order to speed up the process, where possible.
Conditional Branching—When workflow tasks need to be completed in a specific order, the tool should allow for automated routing to each participant once each task has been completed.
Attachments—The tool preferably allows participants to attach content related to their tasks in the flow.
Override Capability—If a participant in the workflow has not responded within a specified period of time, the tool will be able to prompt an alternate participant to complete that task or assign someone else to the task. It preferably also allows for an exception rule and appropriate documentation of that exception.
Apply Workflow to Documents and Records—The workflow tool preferably is able to be applied to documents and records to ensure retention schedules are enforced.

The benefits of the workflow and business process management module 320 may include: increased associate productivity; reduced duplication of effort; increased communication; increased collaboration; and, better decision-making.

The system 300 may further include a collaboration module 322. Collaboration includes the methods, tools and technologies used to work with other individuals and entities within and outside of an organization. The collaborative communities team 238 (see FIG. 5) works with business units 244 to establish appropriate collaborative communities such as communities of practice, affinity networks, learning communities, and project communities. These communities will use various collaboration tools including but not limited to online discussion boards, instant messaging tools, online meeting tools (e.g., WEBEX®), blogs, and wikis. Relevant features of the collaboration module 322 may include:
Discussion Boards—Online discussion board capabilities, if used properly, can centralize communications and replace the need to e-mail back and forth among groups of people. This will help reduce the load on e-mail servers, reduce the amount of time associates spend managing e-mail, and eliminate the unnecessary duplication of content. It also allows new hires or new team members to see all past communications.
Instant Messaging—Instant messaging has been shown to reduce the number of e-mails and increase team communication and collaboration since it offers a third communication alternative from e-mail and telephone. Instant messaging is more immediate than e-mail but less intrusive than a phone call. It also allows others to see who is currently at their computer and whether they are busy or available.
Online Chat Rooms—Online chat rooms are virtual rooms that associates can enter to text chat with other associates on a predefined topic or for predetermined purpose. This feature provides another avenue for “water-cooler” chats but extends it beyond geographical boundaries. Some of the most innovative ideas can come from these “water-cooler” chats.
Online Meeting Tools—Online meeting tools, such as WebEx, tends to increase the communication and collaboration among associates in different locations as well as reducing travel costs.
Blogs—Blogs are sites that anyone can create and use to post their own information, share opinions, best practices, knowledge, etc. with others. Blogs can be organized around themes, topics, projects, yourself (as a way to promote and advertise your skills and opinions), etc.
Wikis—Wikis are sites that anyone can add content to and edit any of its pages. Wikipedia.com, a free online encyclopedia that anyone in the world can edit and contribute content to, is an excellent example of the power of wikis. Some research studies have shown Wikipedia.com to be more accurate than Britannica.com (an online encyclopedia that one needs to pay for). Wikis can be set up for the purpose of collaboratively creating manuals, reference guides, documentation, web sites, organization encyclopedias, etc. Once a wiki tool is available for use at an organization, it is recommended that a wiki be used to create an encyclopedia where everyone at the organization can contribute to and help maintain.

The benefits of the collaboration module 322 may include: increased number of innovative ideas and best practices; viral-speed spread of information across the organization; stronger relationships between associates; increased associate productivity and team work; reduced duplication of effort; maximum use of tacit knowledge; reduced number of e-mails to manage; and, increased communication and collaboration between associates.

The system 300 may further include a business intelligence module 324. Business intelligence is high level reporting and analysis of information to support decision-making. As used herein, the term “business” is intended to include all types of organizations regardless of whether profit is a motive in the organization. As a basis for the business intelligence capability, basic reporting must be possible from which to pull the business intelligence reports. This type of reporting usually aggregates a variety of other reporting mechanisms. Relevant features of the business intelligence module 324 may include:
Reporting Features—Business intelligence is based upon basic reporting features that are part of the horizontal and vertical technologies across the organization. Basic metrics should be gathered in each tool and rolled up into reports that could be used in Business intelligence reports.
Business Intelligence—High-level dashboards that report near real time data for analysis by executives to help achieve business goals.
Flexible Reporting—Can choose reports that an end user needs based on role rights and needs. Would be able to drill down into specific high levels of reports for more detail.

The benefits of the business intelligence module 324 may include: improved decision-making; improved efficiency; and, improved profits.

The system 300 may further include a search module 326. In the knowledge management system 300, the search module 326 can provide a searching function to find all types of content based on the keywords that are entered. A search can find content stored in different sources, such as web sites, file systems, mail servers and databases. The results can be organized in different ways, as defined by the users. Relevant features of the search module 326 may include:
Keyword Synonyms—One of the major issues with many search engines is that it searches and matches only the exact keywords that were entered by the user. Since it is very likely that different users will use different words to refer to the same thing, having the search engine automatically search also synonyms for the keywords they enter will increase the likelihood of a match.
Preferred Keywords—Since users may not be accustomed to the way the system has categorized the content they are interested in, allowing users to attach their own keywords to the content would help make searching more personalized and allow users to keep their own naming conventions instead of changing them.
Best Bets—Best Bets or relevancy rating enhance search efficiency and provide guidance to users by directing them to people, sites, documents, or other items considered particularly relevant to their search. Best Bets are should be displayed at the top of a search results list.
Saved Searches—Allows users to save the search or query criteria so they can quickly run the search again whenever needed or they can automatically be alerted if the results of the search ever changes.
Site Indexing—Site indexing is the easiest way to add content to the portal site for searching. When a user adds a site, they have the option to include its contents in search results. A search administrator can have sites automatically approved for searching or can manage approval for each site. After approval, a site is indexed and its contents appear in search results.
Alerts—Users can ask to be alerted when changes occur to the results for a specific search.

The benefits of the search module 326 may include: reduced search time for information; increased associate productivity; better decision-making; reduced need for training; and, reduced need to bother busy associates for standard information.

The system 300 may further include an expert identification module 328. A way to tap into tacit knowledge is to know who knows what in an organization and leverage talent and expertise when the need or project arises. In large organizations opportunities to leverage in-house expertise may be lost due to not knowing everyone's profile or background in the organization. When the need or project arises, the decision as to who should best be on the project or best meet that need is usually based on who someone knows and not everyone knows everybody in the organization. Relevant features of an expert identification module 328 may include:
Personal Profile Blogs—These personal spaces can be used to showcase one's areas of expertise and experience and these spaces should be included in the search database.
Expert Identification Systems—Tools such as ACTIVENET® and ILLUMINO™ by TACIT KNOWLEDGE™ (http://www.tacitknowledge.com/) are an automated way of identifying experts in the company as well as help quickly and efficiently reduce the chances of duplication of effort in the organization. These systems automatically and privately monitor e-mails, documents on shared drives, web sites, etc., and find connections and keyword similarities between content and alerts the owners of the content privately. Also, when a user does a search in this system, the system can find matches with other users. Users and their information is not shared until the user that owns the content gives their consent to the request, thereby helping to protect their privacy if information is not supposed to be shared.
Knowledge Transfer Tools—Tools such as VIRTUAL GURU® by Atlas Island Media, Inc. may help quickly and easily capture critical “tribal” knowledge or expertise before it leaves the company due to baby boom retirement, associate turnover, personal or family leaves, off-shored jobs or roles, mergers or acquisitions, and reductions in workforce. These tools allow experts or SMEs (Subject Matter Experts) to quickly record their knowledge and save in MP3 format to a searchable database.

The benefits of the expert identification module 328 may include: increased associate satisfaction and engagement; reduced duplication of effort; maximum use of tacit knowledge; preserve and protect intellectual capital; and, faster time-to-competency for new associates or associates in new roles.

It will be appreciated that each of the modules 302-328 of the system 300 may have the following features:
Consistent Look & Feel—Each module preferably is well organized and provides the ability for an organization to apply a consistent look and feel to it.
Usage Tracking Turned On—Each module preferably has usage tracking turned on so that the knowledge management function can analyze who, how many, when, and why it is being used and implement improvements based on those analyses.
Configuration vs. Customization—Each module preferably requires as little customization as possible for two reasons. One, customization makes upgrades difficult or impossible. Two, customization requires programmers, which are costly. Configuration allows for the knowledge management function to configure the solution for specific purposes without having to program the code directly. Some programming may be required, but it should be object-oriented so that upgrades can be made without information loss and will not compromise the object code.
Security & Access Granularity—Each module preferably allows for high level security and access definitions, but should be able to allow item-level security to be applied by the content owners, where needed for confidentiality reasons.
Different Types of Administrator Rights—Each module preferably has multiple levels of administrator rights. The most important requirement is that content owners (e.g., business unit knowledge managers 245—see FIG. 5) should have the right to administer the solution with little or no IT administrator support.
Offline Capabilities—Each module preferably has the capability to pull information offline for associates who may be traveling. It preferably is able to allow this with little or no IT support.
Office Integration—Each module preferably is native in the various MICROSOFT OFFICE XP® applications used regularly by associates. It preferably is native in other applications used daily (e.g. ADOBE® ACROBAT®).
Role-based Personalization—Each module preferably allows associates to view only what is relevant to their role in the organization 10, while it should also provide robust search capability to search other content to which that person has access.
Classification—Each module preferably allows for configuration of classification data.
Taxonomy—Each module preferably allows for configuration of taxonomies so that searching on the content is robust.
Metadata—Each module preferably allows for the configuration of metadata on the content.

Suitable technologies for the modules 302-328 include horizontal technologies that are applied company-wide where needed. Each of the modules 302-328 may be designed to standardize the content and provide a framework for improved organization processes and compliance. Suitable technologies for the modules 302-328 further include vertical technologies are designed to be placed on top of the horizontals in such a way as to meet specific organization needs that are not met by the horizontals alone.

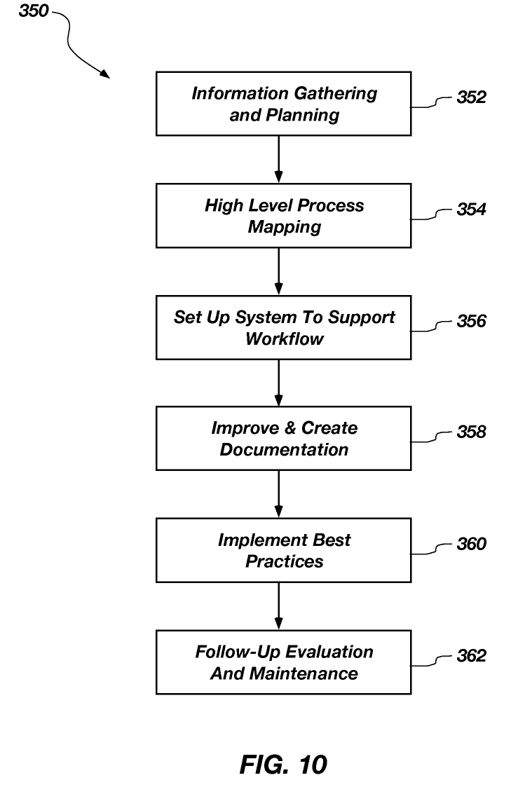

Referring now to FIG. 10, there is depicted a flow diagram 350 for carrying out an embodiment of the present disclosure. At step 352, an information gathering and planning process takes place. During the information and planning process, individuals and teams within an organization are educated about the implementation process and the benefits of knowledge management. During step 352, a survey may be administered to learn more about the current knowledge management practices and its shortcomings. In one embodiment of the present disclosure, the survey is designed to assess the extent of a team's or group's knowledge management issues. The responses to the survey are preferably kept private from other respondents. The information gathered in the survey is preferably aggregated to gain a clearer understanding of the challenges a particular team or group is facing. The information gathered by the survey may also be used as a metric by which to measure success later in the project. The survey may be administered over a computer network.

The survey administered in step 352, may inquire into the following areas for each individual taking the survey. The individual may be requested to identify the geographic region in which he or she works. The individual may also be requested to identify his or her department, business unit, division or any other chain of command to which the person is subject. The individual may also be requested to identify his or her job title and value. Next, the individual may be requested to answer a series of questions with one of the following responses: strongly agree, agree, neutral, disagree, and strongly disagree. These questions may include:
My team has been impacted by talent leaving the company (e.g., retirement, turnover) and the knowledge that leaves with them.
In my team, critical knowledge is not documented (“tribal” knowledge).
My team does not measure or have metrics that gauge the success or failure of the team's initiatives.
I have experienced information overload.
I have witnessed the duplication of content or documents, different versions or information chaos in my team.
I find it difficult to locate information on intranet sites.
I find it difficult to find documents on personal and/or network shared drives.
I feel that my team's information is not well organized.

My team finds it difficult to manage and update content on intranet sites, or that the information on intranet sites is outdated or obsolete.
My team finds it difficult to manage and update documents on personal or shared network drives, or that the information is outdated or obsolete.
I experience e-mail overload and chaos, or have difficulty finding e-mail when needed.
I have witnessed duplication of effort, i.e., “the left hand doesn't know what the right hand is doing” within my team or between my team and other business units.
My team has difficulty finding relevant information when required to for legal or compliance reasons.
My team struggles with capturing and sharing best practices between team members or across the organization.
I have trouble knowing who knows what in my team or organization.
My team is concerned about protection of knowledge assets (security and confidential information).
My team is challenged by company acquisitions or team mergers and the need to quickly combine knowledge of both organizations.
My team is challenged by reduction of workforce, reorganization, or retooling of workforce or teams.
I find that information is hard to understand and/or information is not well-written or formatted.

In addition, the survey takers may be requested to estimate the average number of hours per week they personally lose in productivity due to the issues listed in the survey. The survey takers may also be asked to provide information on how many emails does the survey taker have in his or her inbox right now (regardless of whether they are read or unread).

At step 354, high-level process mapping of the processes of the organization 10 are completed. This may be accomplished on a team-by-team basis. First, the processes of the organization are identified for each process that needs to be defined, improved, and documented. A high-level process map form may be utilized for preliminary information about the processes.

Once a process is identified, it may be given a name for future reference. In addition, the individuals responsible for the process may be identified. A subject matter expert, sometimes referred to herein as an “SME,” for the process may also be identified. Typically, a third-party disassociated with the process should be utilized to gather the information in step 354. This will ensure that the information will be collected in a timely manner and ensure that the information is captured from a new person perspective and not an expert perspective. Typically, the gatherer of the information will interview the subject matter expert for the process to collect the steps needed to complete the process. Several interviews by the gatherer of information may be necessary to fully obtain the necessary information about a process. A series of meetings and communications may be necessary to reach a consensus and to discuss discrepancies, issues, and improvement suggestions. The gatherer of the information may ask the subject matter expert any of the following questions to facilitate gathering information about a process:
Describe what the end result of the process preferably looks like when the process is executed successfully.
What issues/events might affect the outcome of the process?
Are there any challenges with the current process?
What can happen if these challenges are not handled appropriately?
How can these challenges be resolved successfully?
What steps would you eliminate to simplify the process?
What additional information/steps would improve the process?
What data (statistics, reference information, sources) does one need to complete the process?
What skills are needed to complete the process?

Once a consensus is reached on how a process should preferably operate, an information designer will then need to determine the best way to capture the details of the process and then develop it. The information designer will also be responsible for developing any templates and/or forms that were identified as a part of the process.

The completed process map may identify the key individuals needed to support or do a process, the documents and knowledge that are needed to support or do a process and the tools and technology needed to support or do a process.

During this step 354, all existing documentation relevant for supporting or doing the process should preferably be identified. Further, all knowledge necessary to support or do the process that has not been documented preferably are also identified. Appropriate high level names for computer directories and folders are preferably selected. As a result of step 354, there should exist enough information to complete a first-pass configuration of the system 300 according to the present disclosure.

At step 356, a solution is devised to support the processes identified in the previous steps. Existing data and documents are migrated to a centralized electronic storage medium, also referred to herein as a knowledge database.

At step 358, knowledge is standardized and undocumented knowledge is documented. This step 358 may include gathering information from each subject matter expert to obtain undocumented and tacit knowledge that is needed to support or accomplish a process. This undocumented knowledge and tacit knowledge are then standardized, documented and centralized in the centralized electronic storage medium. In addition, existing data, content and documents should be improved.

At step 360, in accordance with the present disclosure it is preferred to implement the best practices needed to support mutual collaboration between individuals and teams and groups within an organization. This may include providing training sessions for the individuals, teams, groups, and subject matter experts. A support system is preferably also established. Collaboration should be facilitated by the establishment of groups such as affinity networks, learning communities, communities of practice and project communities. Reference guides and training on various communication and collaboration tools and technologies such as instant messaging, online meeting tools and personal e-mail in addition to task management systems which may be provided.

In one embodiment of the present disclosure, step 360 includes the implementation of collaborative technology such as Microsoft Corporation SHAREPOINT® Server. Use of collaborative technology may facilitate creating standard templates (public, private, project) for a standard look and feel and site navigation. This may further facilitate the creation of a master-planned site and information hierarchy to support collaboration and target audience. This may also facilitate intranet governance and central and federated records management. Individuals should be trained to use discussion boards and announcements to reduce e-mail traffic and management. All folders in a document library are preferably organized by criticality. Information design standards are preferably established to ensure quality data and content. Public and private sites may be established with portals. Portals may be employed to connect individuals to information, expertise and applications.

At step 362, evaluation and maintenance is conducted. This step may include monthly and then quarterly meetings with the appropriate individuals. Bi-annual audits may be conducted to assess the effectiveness of the program. Best practices should be continued to be identified and shared through quarterly communications. Ongoing training is preferably provided. Steps 352 through 362 may be repeated again as processes and information changes dictate.

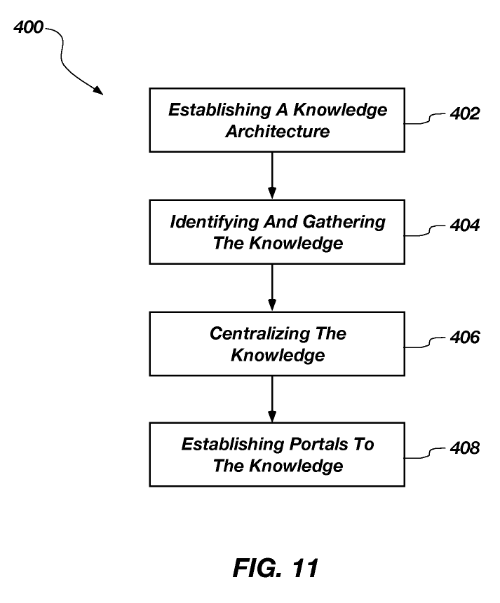

Referring now to FIG. 11, there is depicted a flow diagram 400 for carrying out an embodiment of the present disclosure. At step 402, a knowledge architecture for an organization is established. The knowledge architecture may include an extranet and an intranet. The extranet may include public external client-facing spaces. The intranet may include private intra-group spaces, private inter-group spaces, and public internal client-facing spaces. At step 404, the knowledge of the organization is identified and gathered. At step 406, the knowledge is centralized, such as in a computer readable storage medium. At step 408, portals are established for accessing the knowledge.

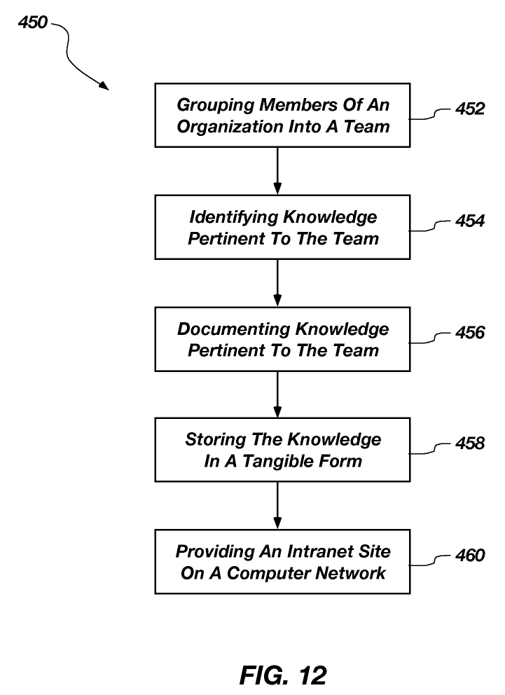

Referring now to FIG. 12, there is depicted a flow diagram 450 for carrying out an embodiment of the present disclosure. At step 452, members of an organization are grouped into a team. The members of the team may have similar roles and responsibilities in the organization. At step 454, knowledge pertinent to the team is identified. This may include both tacit and explicit knowledge. At step 456, knowledge pertinent to the team is identified. At step 458, the knowledge is codified and stored in an electronic storage medium in a tangible form. At step 460, access is provided to the knowledge via an intranet site on a computer network.

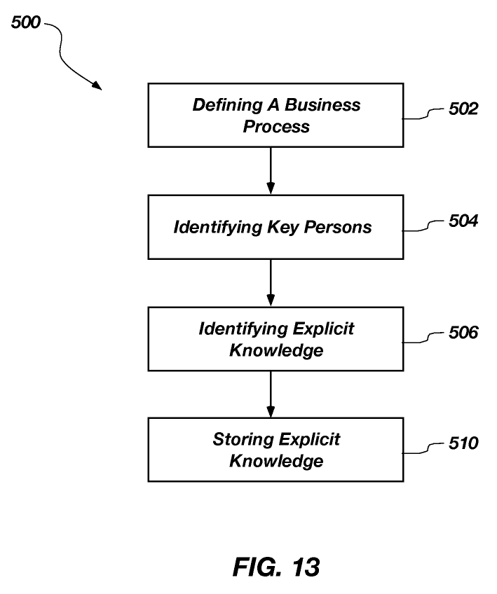

Referring now to FIG. 13, there is depicted a flow diagram 500 for carrying out an embodiment of the present disclosure. At step 502, a business process of an organization is defined. At step 504, key persons of the business process are identified. At step 506, explicit knowledge is identified. At step 510, the explicit knowledge is stored in a computer readable storage medium.

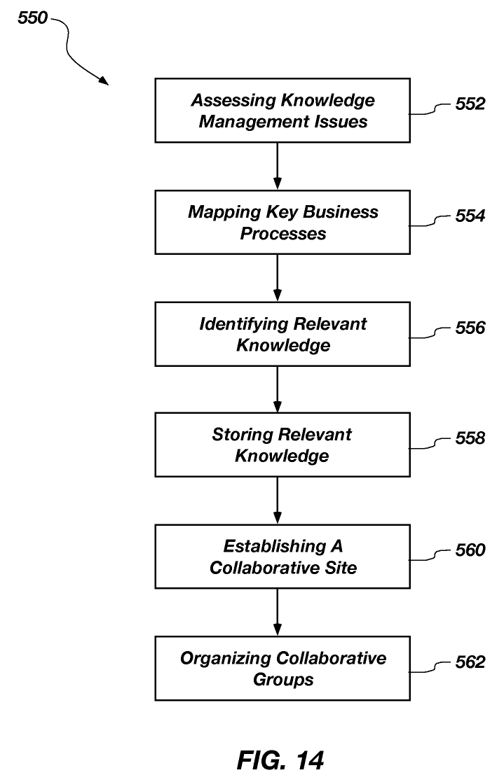

Referring now to FIG. 14, there is depicted a flow diagram 550 for carrying out an embodiment of the present disclosure. At step 552, the knowledge management issues of an organization are assessed. At step 554, key business processes of the organization are mapped. At step 556, relevant knowledge of the organization is identified. At step 558, the relevant knowledge is stored in a computer readable storage medium. At step 560, a collaborate site is established on a computer network. At step 562, collaborative groups or teams are organized.

It should also be noted that the present disclosure is useful for searching and providing structured data. Structured data is explicit knowledge and includes any information that is transactional in nature or that can be easily recorded. It often includes data that is actually produced by a transaction itself. For example, transactional systems may include IMPULSE™ (order management), ORACLE® (Purchasing), PEOPLESOFT® (Human Resources), SALESFORCE.COM® (Contact Management System & Sales), KRONOS® (Payroll) and other systems which are now available and which may become available in the future as can be selected by those skilled in the industry.

A knowledge management system pursuant to the present disclosure is able to prompt a user to go to a structured data source, pull data from it, and then bring it back to the knowledge management system for analysis or reporting. The present disclosure is also able to manage unstructured data. Unstructured data is also explicit knowledge and includes all information that is not structured data and is generally harder to organize and analyze than structured data. Examples include images, documents, records, web content, email, video, voice mail, instant messages, workflows, reporting, etc. A knowledge management system pursuant to the present disclosure may prompt a user to go to an unstructured data source, pull data from it, and then bring it back to the knowledge management system for analysis or reporting.

One benefit included in the present disclosure is the centralization of data typically stored in a variety of locations and formats such as intranets, e-mails, computer hard drives, department and personal network drives, various memory devices, hard copy paper formats and a wide variety of databases. Thus, by ensuring that individuals in an organization focus on the right things all the time, the implementation of the present disclosure creates greater clarity around priorities and critical business needs by helping to surface key information necessary for decision-making. The present disclosure is able to get the right (reliable, accurate and up-to-date) information to the right people at the right time with the right amount of detail. Further, the present disclosure enables research and development, product development and other new ideas to surface and develop into best practices at a faster rate, rather than continuing to go “undiscovered” or result in duplication of effort.

In addition, easily managing alliances, mergers, acquisitions and/or outsourcing through the present disclosure is another benefit thereof. When organizations join together, knowledge sharing is critical but can be stymied by a clash of cultures, incompatible systems, conflicting priorities, etc. The present disclosure can bridge these gaps by providing an open flow of information, fostering greater teamwork and collaboration. The present disclosure can also quickly retool the workforce of the organization to prepare them for constant change and new challenges.

The present disclosure is therefore characterized by one or more of the following:

1. Centralize knowledge as much as possible to reduce duplication of content, streamline maintenance process, and allow knowledge to be shared throughout an organization instead of localizing the knowledge (e.g., global portal-based intranet, role-based information visibility in Outlook, centralized communications in online discussion boards, move more information out of the brains of an organization's members (“tribal” or tacit knowledge), e-mail systems, and personal network or local drives into a shared space, (documents, etc.);

2. Make knowledge as accessible as possible to the appropriate people through computer networks (e.g., automatic identification or no login, no multiple passwords maintenance, good response time or performance of system, etc.);

3. Ensure knowledge is accurate (e.g., identify subject matter expert for processes), relevant (e.g., identify manager responsible for relevancy and appropriateness of content), up-to-date (e.g., attaching an expiration date to information on a computer network) and in the best format (e.g., written or reviewed by an information designer);

4. Pull technology: Users can quickly locate information using a powerful search engine that can search across all information types and multiple sources;

5. Push technology: The organization or the system can automatically push information to users based on their information preferences or user profile (i.e., users can choose information most important to them and organize that information to best support their workflow and choose what they would like to be alerted on from a web site) as well as what the organization thinks they need to know (also sometimes referred to as “role-based” information management);

6. Ability to collaborate on the knowledge and innovate to develop best practices;

7. Secure and protect knowledge; and

8. The solution provided by the present disclosure is scalable and flexible to accommodate growth, geographical dispersion and new uses.

In another embodiment of the present disclosure, the following steps are implemented:

Step 1: Information gathering and planning. Complete a knowledge management needs assessment to assess the extent of the knowledge management issues, identify current metadata, classification systems, and taxonomies, identify where information may overlap with information in other functional groups or business units, identify key project players, define their roles, and identify their critical business processes. Develop a knowledge management implementation and change management project plan to manage the project.

Step 2: High-level process mapping. Map key business processes at a high level to identify what is most important and what knowledge needs to be captured, procured, or documented. Identify where some of these processes are lacking or can be improved by utilizing proven processes.

Step 3: Sites set up to support workflow and information needs. Set up intranet sites to support workflow based on processes and need for communication and collaboration internally within the team (e.g., a private team site) as well as externally outside the team (e.g., a site targeted for all of an organization's associates). Implement knowledge management and information design standards and best practices on the sites. Move content from shared network drives, personal hard drives, other storage devices, e-mails and people's brains into the sites. Develop a site usage and maintenance plan.

Step 4: Process detail documentation. Define, improve (for example quick hits only) and document those process details. Identify any potential Six Sigma projects and refer to COE where applicable. Review documents on shared network drives, intranet sites, personal hard drives, other storage devices and e-mails for existing documentation and convert them into effective documentation using proven information design methods. Examine business intelligence and reporting needs of the business unit.

Step 5: Implement other knowledge management best practices. Introduce and implement instant messaging, Outlook productivity, WebEx and other knowledge management best practices. Consider joining or setting up collaborative groups such as affinity networks, learning communities, communities of practice and project communities.

Step 6: Follow-up evaluation and maintenance. Conduct aperiodic (e.g., bi-annual) audit to assess effectiveness of solution and maintain solution.

As a result, a knowledge management solution according to the present disclosure may be implemented in two major phases:

1. Phase I—Focus on managing explicit knowledge and turning “tribal” knowledge into explicit knowledge. Apply steps 1-4 (listed immediately above) of the knowledge management methodology (all explicit knowledge best practices) to business units. This is an important first step to get control of the information chaos and understand what knowledge assets the organization should leverage.

2. Phase II—Focus on managing tacit knowledge. Apply steps 5-6 (listed immediately above) of the knowledge management methodology to business units to address tacit knowledge, measure the success of the knowledge management solution, and maintain the knowledge management solution.

After the entire organization 10 (see FIG. 1) is up and running on the knowledge management system 300 (see FIG. 9) using the architecture 50 (see FIG. 2) as described herein, duplication of resources, data, and processes between teams or business units will be more easily identified and resolved either by eliminating the duplicates, consolidating them, or linking them together via collaborative groups. Since knowledge and processes will always change, implementation of the knowledge management steps discusses herein should be a continuous, permanent process and eventually become normal operating procedure of an organization.

It will be appreciated that there are at least three principle competitive advantages of the present disclosure and methodology that are uniquely different from the previously available knowledge management systems, including the following:

1. The present disclosure focuses on key organization processes and identifies what knowledge is most critical to the organization and what information needs to be captured, codified, protected, and shared and how to best organize that knowledge.

2. The use of a third party approach to gather the information for knowledge management solves the problem of getting subject matter experts to document their knowledge (e.g., job security, knowledge hoarding, already know the process in their mind), ensures that knowledge is documented from a the perspective of an uninitiated person and not an expert point of view and ensures that it is documented in a timely manner.

3. Information designers can be used to develop the documentation and templates, intranet site, or other media to avoid the problem of ineffective or poorly written and designed documentation, web sites, or other media and to ensure the knowledge is captured/delivered in the most effective medium. Information designers use the methods of the present disclosure that have been proven by over 50 years of research to increase productivity by up to 70% and reduce the need for training by up to 50%.

Once a knowledge management system according to the present disclosure is implemented in an organization, it may be useful to monitor the success of the system. The following are several alternatives for measuring the success of knowledge management beginning with the easiest (easy to measure) but lowest value (not as useful) metric to the hardest (hard to measure) but highest value (very useful) metric.

1. Hits to web site.

2. Associate attitudes.

3. Executive feedback.

4. Accuracy and rework.

5. Reduction of redundancy.

6. User satisfaction.

7. Responsiveness.

8. Learning.

9. Level of collaboration.

10. Recruitment and retention.

11. Benchmarking (year-over-year improvement in targeted areas).

12. Innovation.

13. Productivity (disintermediation of work, streamline process, do more with less cost).

14. Competitive differentiation.

15. Balanced scorecard.

It is preferred that a subset of the above metrics be chosen to measure at the onset of the program to assess the “before” state and periodically (e.g., every six months) afterwards to assess the effectiveness of the implementation of the present disclosure. The Transforming Your Intranet benchmark report (Melcrum Publishing, 2006), which is hereby incorporated herein by this reference in its entirety, recommends the following types of metrics:
Log analysis—(most preferably tracked on a weekly basis, but preferably at least monthly)—page views, visits, unique visitors, and requested pages.
Cost per visit—divide the total yearly cost of the intranet by the total number of visits to the intranet to show how much it is costing an organization.
User satisfaction—using a 1 to 10 scale since most users are accustomed to using a 10 point scale to rate consumer products or services.
Return on Investment—hard benefit examples include less paper, less hardware, less headcount, increased sales, and soft benefit examples include increased associate productivity, better customer satisfaction, faster time to market and improved employee retention.

Those having ordinary skill in the relevant art will appreciate the advantages provided by the features of the present disclosure. For example, it is a feature of the present disclosure to provide a system for managing knowledge needed by an organization for accomplishing desired processes. Another feature of the present disclosure to provide such knowledge that is accurate, relevant, up-to-date, and in the best format. It is a further feature of the present disclosure, in accordance with one aspect thereof, to provide a push and pull technology such that members of an organization are constantly updated with the most relevant information pertinent to their roles in the organization. It will be appreciated that the knowledge acquired through the methodology described herein may be stored in a centralized knowledge database.

In the foregoing Detailed Description, various features of the present disclosure are grouped together in a unitary embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features the foregoing disclosed embodiments. Thus, the following claims are hereby incorporated into this Detailed Description by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in function, manner of operation, order of operations, size, materials, shape, form, assembly and use may be made without departing from the principles and concepts set forth herein.

What is claimed is:

1. A method of managing knowledge in an organization, said method comprising the steps of:
establishing a knowledge architecture, said knowledge architecture defining how the knowledge in an organization will be organized;
identifying and gathering the knowledge within the organization;
centralizing the knowledge in a centralized electronic storage medium pursuant to the knowledge architecture; and
establishing portals to the knowledge in the computer-based system such that members within the organization can access the knowledge from remote computer terminals.

2. The method of claim 1, further comprising the step of mapping key business processes of the organization.

3. The method of claim 1, further comprising the step of pushing knowledge in computer-based system to designated members within the organization.

4. The method of claim 1, further comprising the step of pulling knowledge from designated members within the organization.

5. The method of claim 1, further comprising the step of establishing collaborative sites in a computer network for groups within the organization.

6. The method of claim 1, wherein the step of centralizing the knowledge in a centralized electronic storage medium comprises the step of moving content from at least one of a shared network drive, personal hard drive, and e-mail to the centralized electronic storage medium.

7. The method of claim 1, further comprising the step of documenting knowledge in a person's brain and placing it in the centralized electronic storage medium.

8. The method of claim 1, further comprising the step of establishing a usage and maintenance plan for the centralized electronic storage medium.

9. The method of claim 1, further comprising the step of establishing collaborative groups of members within the organization.

10. The method of claim 1, further comprising the step of identifying key business processes of the organization.

11. The method of claim 1, further comprising the step of establishing an intranet site accessible to the members of the organization.

12. The method of claim 1, further comprising the step of documenting tacit knowledge.

13. The method of claim 1, further comprising the step of establishing client portals to the knowledge in the centralized electronic storage medium.

14. The method of claim 1, further comprising the step of establishing employee or associate portals to the knowledge in the centralized electronic storage medium.

15. The method of claim 1, further comprising the step of classifying the knowledge.

16. The method of claim 1, further comprising the step of attaching expiration dates to the knowledge.

17. The method of claim 1, further comprising the step of providing metadata for the knowledge.

18. The method of claim 1, wherein metadata comprises at least one of the following: a title, an identity of a subject matter expert; an approved by message; a description of a document; a status of a document; a next review date; and keywords.

19. The method of claim 18, wherein the metadata further comprises at least one of the following: a country or region and an identification of a target audience.

20. The method of claim 1, wherein the knowledge comprises official knowledge and unofficial knowledge.

21. The method of claim 1, further comprising the step of establishing user filters for the knowledge.

22. The method of claim 1, further comprising the step of dynamically updating the

23. The method of claim 1, further comprising the step of removing expired knowledge.

24. The method of claim 1, further comprising the step of providing a search engine for the knowledge.

25. The method of claim 1, further comprising the step of tracking usage of the knowledge.

26. The method of claim 1, further comprising the step of granting levels of access to the knowledge.

27. The method of claim 1, further comprising the step of limiting access to the knowledge based upon a user's responsibilities.

28. A method of improving collaboration among members of an organization, said method comprising the steps of:
grouping the members of the organization into at least one collaborative team;
identifying knowledge pertinent to the at least one collaborative team;
documenting the knowledge pertinent to the at least one collaborative team in a tangible form;
storing the knowledge in the tangible form in an electronic storage medium;
providing an intranet site on a computer network as a portal to the knowledge in the tangible form on the electronic storage medium.

29. The method of claim 28, further comprising the step of mapping processes pertinent to the at least one collaborative team.

30. The method of claim 29, further comprising the step of identifying key individuals for accomplishing the processes.

31. The method of claim 29, further comprising the step of identifying knowledge and documents related to the processes.

32. The method of claim 28, further comprising the step of identifying common methodology of the at least one collaborative team.

33. The method of claim 28, further comprising the step of centralizing all electronic communications for the at least one collaborative team.

34. A method for facilitating a business process, said method comprising the steps of:
defining the business process;
identifying key persons needed to support or do the business process;
identifying explicit knowledge needed to support to do the business process; and
storing the explicit knowledge in an electronic storage medium such that the explicit knowledge is available over a network.

35. The method of claim 34, further comprising the step of identifying a subject matter expert for the business process.

36. The method of claim 34, further comprising the step of improving the explicit knowledge.

37. The method of claim 34, further comprising the step of identifying all tools/technology needed to support a process.

38. The method of claim 34, further comprising the step of identifying tacit knowledge needed to support or do the business process.

39. The method of claim 38, further comprising the step of documenting the tacit knowledge.

40. The method of claim 39, further comprising the step of storing the tacit knowledge in the electronic storage medium such that the tacit knowledge is available over the network.

41. The method of claim 34, wherein the step of defining the business process, includes mapping the inputs and outputs of the business process.

42. The method of claim 34, further comprising the step of naming the process.

43. The method of claim 34, further comprising the step of identifying the roles of the key persons.

44. A method of improving workflow in an organization, said method comprising the steps of:
assessing knowledge management issues of the organization;
mapping key business processes of the organization;
identifying relevant knowledge for each of the key business processes;
storing the relevant knowledge, or links thereto, for each of the key business processes in a centralized electronic storage medium;
establishing a collaborative site on a computer network for each of the key business processes, each of the collaborative sites providing access to the relevant knowledge for its key business process; and
organizing members of the organization into collaborative groups for each of the key business processes and providing them access the corresponding collaborative sites.

45. The method of claim 44, wherein the step of assessing knowledge management issues of the organization comprises the steps of identifying key project players, defining roles of key project players, and identifying critical business processes.

46. The method of claim 44, wherein the step of mapping key business processes of the organization comprises the step of mapping key processes at a high level.

47. The method of claim 44, wherein the step of identifying knowledge for each of the key business processes comprises the step of identifying explicit knowledge and tacit knowledge.

48. The method of claim 47, further comprising the step of documenting the tacit knowledge.

49. The method of claim 48, further comprising the step of storing the tacit knowledge in the centralized electronic storage medium.

50. The method of claim 44, further comprising the step of employing collaborative technology.

51. A method of improving workflow in an organization, said method comprising the steps of:
centralizing knowledge for the organization in a knowledge database;
making the knowledge in the knowledge database accessible to members of the organization;
ensuring the knowledge in the knowledge database is accurate, relevant, and up-to-date;
allowing the members of the organization to choose knowledge in the knowledge database most important to them and organize it to best support their work flows;
allowing the members of the organization to choose knowledge preferences; and
automatically pushing information to members of the organization based upon their preferences.

52. A computer-based system for managing knowledge in an organization for completing business processes, said system comprising:
a centralized knowledge database on an electronic storage medium, said centralized knowledge database having information stored therein that is organized by business processes; and
a computer network, said computer network allowing members of the organization to access the information in the centralized knowledge database from remote computer terminals.

53. The system of claim 52, wherein the computer network is an intranet.
